(19) United States
(12) Patent Application Publication
(10) Pub. No.: US 2025/0110308 A1
(43) Pub. Date: Apr. 3, 2025

(54) MODULE DRIVE DEVICE

(71) Applicant: ALPS ALPINE CO., LTD., Tokyo (JP)

(72) Inventors: Hiroshi OSADA, Tokyo (JP); Junichiro YOKOTA, Miyagi (JP)

(21) Appl. No.: 18/897,517

(22) Filed: Sep. 26, 2024

(30) Foreign Application Priority Data
Sep. 28, 2023 (JP) 2023-168406

(51) Int. Cl. G02B 7/02

(52) U.S. Cl. CPC G02B 7/02

(57) ABSTRACT

A module drive device that includes: a module holder configured to hold an optical module including a lens body and an imaging device; a connection member connected to the module holder such that the module holder is swingable around a first axis intersecting an optical axis direction; a fixed-side member connected to the connection member such that the connection member is swingable around a second axis perpendicular to an axial direction of the first axis; a driver that moves the module holder with respect to the fixed-side member; a first engagement part provided such that the module holder is swingable around the first axis; and a second engagement part provided such that the connection member is swingable around the second axis.

### CROSS-REFERENCE TO RELATED APPLICATIONS

The present application is based on and claims priority to Japanese Patent Application No. 2023-168406 filed on Sep. 28, 2023, the entire contents of which are hereby incorporated by reference.

### BACKGROUND

### 1. Field of the Invention

The present disclosure relates to a module drive device.

### 2. Description of the Related Art

Conventionally, there has been known an optical unit (module drive device) in which a gimbal mechanism is arranged above a rectangular movable body (optical module) (see Japanese Laid-Open Patent Application No. 2020-166011).

### SUMMARY

A module drive device includes: a module holder configured to hold an optical module including a lens body and an imaging device; a connection member connected to the module holder such that the module holder is swingable around a first axis intersecting an optical axis direction; a fixed-side member connected to the connection member such that the connection member can swing around a second axis perpendicular to the axial direction of the first axis; a driver for moving the module holder with respect to the fixed-side member; a first engagement part provided such that the module holder is swingable around the first axis; a second engagement part provided such that the connection member can swing around the second axis. The connection member is formed of a frame-shaped metal so that the module holder is arrangeable therein, and includes a first extending portion and a second extending portion that are separated from each other in the axial direction of the first axis and extend in an axial direction of the second axis, and a third extending portion and a fourth extending portion that are separated from each other in the axial direction of the second axis and extend in the axial direction of the first axis. The first engagement part includes a first support-side engagement portion provided at a central portion in the axial direction of the second axis of each of the first extending portion and the second extending portion, and a first swing-side engagement portion provided on the module holder so as to engage with the first support-side engagement portion. The second engagement part includes: a second swing-side engagement portion provided at a central portion in the axial direction of the first axis of each of the third extending portion and the fourth extending portion, and a second support-side engagement portion provided on the fixed-side member so as to engage with the second swing-side engagement portion.

### BRIEF DESCRIPTION OF THE DRAWINGS

FIG. 1 is a perspective view of an optical module and a module drive device;

FIG. 2 is an exploded perspective view of the optical module and the module drive device;

FIG. 3 is a more detailed exploded perspective view of the module drive device;

FIG. 4 is a perspective view of a module holder, a movable-side metal member, a flexible metal member, and a first metal member;

FIG. 5 is a perspective view of a fixed-side side metal member, a second metal member, a conductive member, and a base member;

FIG. 6 is a three-side view (left side view, top view, and rear view) of a metal member with a shape-memory alloy wire attached thereto;

FIG. 7 is a perspective view of the metal member, the flexible metal member, the conductive member, and the shape-memory alloy wire;

FIG. 8 is a perspective view of a connection member, the metal member, the first metal member, the second metal member, and the shape-memory alloy wire;

FIG. 9 is a perspective view of a cover member, the connection member, the movable-side cover member, the first metal member, and the second metal member;

FIG. 10 is a cross-sectional view of the cover member, the connection member, the movable-side cover member, the first metal member, and the second metal member;

FIG. 11 is a cross-sectional view of the cover member, the connection member, the movable-side cover member, the first metal member, and the second metal member;

FIG. 12 is a three-side view (right side view, bottom view, and left side view) of the optical module and the module drive device;

FIG. 13 is a perspective view of a first assembly including the module holder, the flexible metal member, and the first metal member;

FIG. 14 is a perspective view of a second assembly including the first assembly, the second metal member, the conductive member, and the base member;

FIG. 15 is a perspective view of a third assembly including the second assembly and a connection member;

FIG. 16 is a perspective view of a fourth assembly including the third assembly, the metal member, and the shape-memory alloy wire;

FIG. 17 is a perspective view of a fifth assembly (module drive device) including the fourth assembly and the cover member;

FIG. 18 is a downward perspective view of the module holder, the movable-side metal member, and the flexible metal member;

FIG. 19 is a perspective view of the optical module; and

FIG. 20 is a perspective view of the module drive device and the optical module.

### DETAILED DESCRIPTION OF THE DISCLOSURE

The above-described gimbal mechanism is configured such that the optical module can be rotated about the first axis and the second axis, respectively.

However, the above-described module drive device is configured such that the first axis and the second axis extend along two diagonal lines of the rectangular optical module, and when the optical module rotates about the first axis or the second axis and tilts, a corner of the optical module becomes high. Therefore, the above-described module drive device needs to have a large space for accommodating the optical module, which may make downsizing difficult.

Therefore, it is desirable to provide a module drive device capable of downsizing.

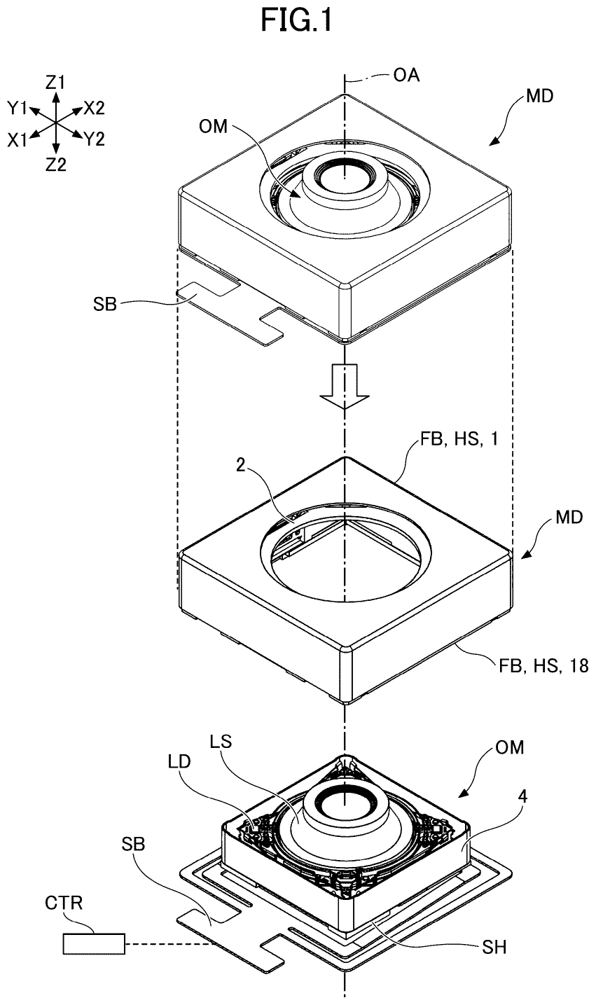

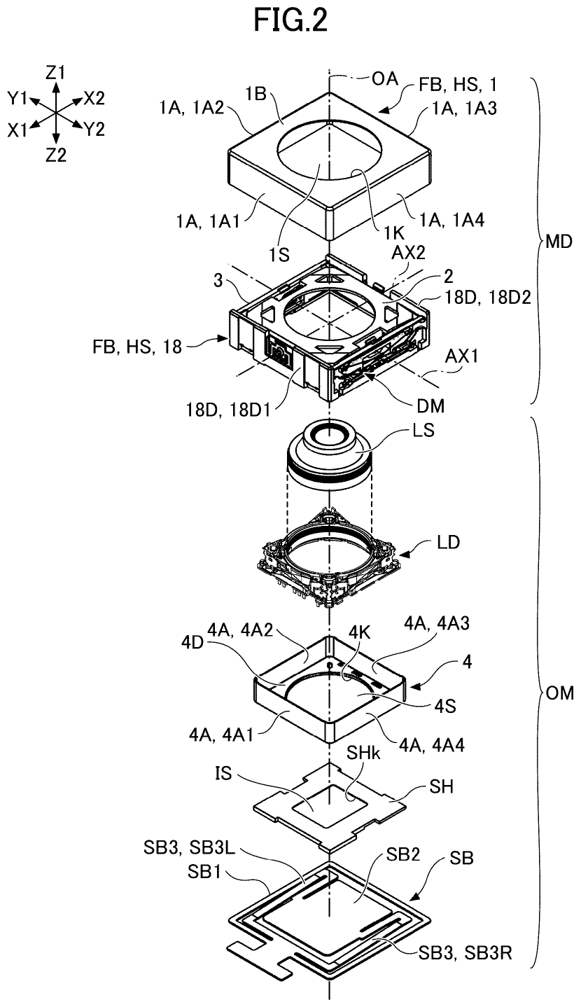

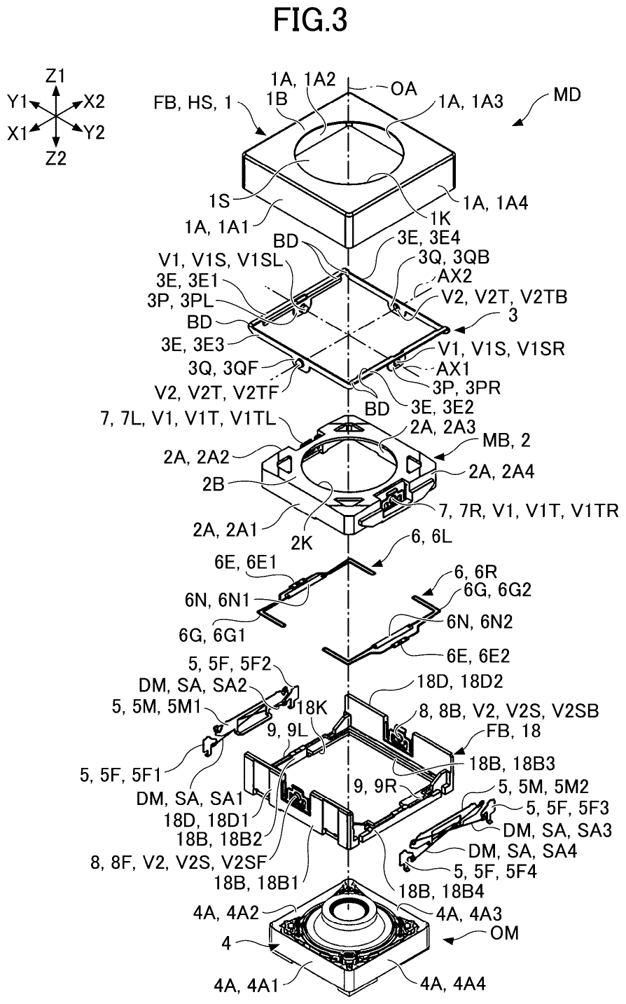

A module drive device MD according to one embodiment of the present disclosure will now be described with reference to the drawings. The module drive device MD is configured such that an optical module OM can be tilted. FIG. 1 is a perspective view of the optical module OM and the module drive device MD. Specifically, an upper figure (a figure above a block arrow) of FIG. 1 is a perspective view of the module drive device MD with the optical module OM attached, and a lower figure of FIG. 1 (a figure below the block arrow) is a perspective view of the module drive device MD with the optical module OM removed. FIG. 2 is an exploded perspective view of the optical module OM and the module drive device MD. FIG. 3 is a more detailed exploded perspective view of the module drive device MD and includes a perspective view of the optical module OM.

In FIGS. 1, 2, and 3, X1 represents one direction of an X-axis constituting a three-dimensional rectangular coordinate system, and X2 represents the other direction of the X-axis. Y1 represents one direction of a Y-axis constituting the three-dimensional rectangular coordinate system, and Y2 represents the other direction of the Y-axis. Similarly, Z1 represents one direction of a Z-axis constituting the three-dimensional rectangular coordinate system, and Z2 represents the other direction of the Z-axis. In FIGS. 1, 2, and 3, an X1 side of the module drive device MD corresponds to a front side (front) of the module drive device MD, and an X2 side of the module drive device MD corresponds to a rear side (back) of the module drive device MD. A Y1 side of the module drive device MD corresponds to a left side of the module drive device MD, and a Y2 side of the module drive device MD corresponds to a right side of the module drive device MD. A Z1 side of the module drive device MD corresponds to the upper side (subject side) of the module drive device MD, and a Z2 side of the module drive device MD corresponds to a lower side (image pickup device side) of the module drive device MD. The same is true in other figures.

The optical module OM is a module including an optical element drive device for driving optical elements. In an illustrated example, the optical module OM includes a lens drive device LD which is an example of an optical element drive device for driving a lens body LS which is an example of the optical element. The lens body LS is, for example, a cylindrical lens barrel provided with at least one lens, and is configured such that its central axis line is along an optical axis OA.

Specifically, as illustrated in FIG. 2, the optical module OM includes the lens body LS, the lens drive device LD, a movable-side cover member 4, an imaging element IS, an imaging element holder SH, and a substrate SB. The movable-side cover member 4 that is open box-shaped and having a substantially rectangular parallelepiped shape accommodates the lens drive device LD therein, and is mounted on the imaging element holder SH mounted on the substrate SB.

The lens drive device LD is configured such that the lens body LS can be moved along the optical axis direction (Z-axis direction) by using a shape-memory alloy wire. The optical axis direction includes an axial direction of the optical axis OA and a direction parallel to the axial direction of the optical axis OA. The lens drive device LD is configured such that the lens body LS can be moved along a direction perpendicular to the optical axis direction (in both the X-axis direction and the Y-axis direction) by using the shape-memory alloy wire. In the illustrated example, the lens drive device LD is configured so as to move the lens body LS by using the shape-memory alloy wire, but may be configured so as to move the lens body by using a member or mechanism other than the shape-memory alloy wire, such as a voice coil motor or a piezoelectric element.

The movable-side cover member 4 is configured so as to function as a housing covering members constituting the lens drive device LD. In the illustrated example, the movable-side cover member 4 is formed of a nonmagnetic metal such as austenitic stainless steel. However, the movable-side cover member 4 may be formed of a magnetic metal.

Specifically, as illustrated in FIG. 2, the movable-side cover member 4 has an outer shape of an open box defining a storage portion 4S. The movable-side cover member 4 includes a side plate portion 4A having a rectangular cylindrical shape and a bottom plate portion 4D having a rectangular annular flat plate shape and provided so as to be continuous with a lower end (end of the Z2 side) of the side plate portion 4A. A circular opening 4K is formed in the center of the bottom plate portion 4D. The side plate portion 4A includes first side plate portion 4A1 to fourth side plate portion 4A4. The first side plate portion 4A1 and the third side plate portion 4A3 face each other, and the second side plate portion 4A2 and the fourth side plate portion 4A4 face each other. The first side plate portion 4A1 and the third side plate portion 4A3 extend perpendicular to the second side plate portion 4A2 and the fourth side plate portion 4A4.

The imaging element holder SH is configured to accommodate and hold the imaging element IS. In the illustrated example, the imaging element holder SH is a substantially rectangular frame-shaped member made of synthetic resin, and its upper surface is joined to a lower surface of the movable-side cover member 4 by an adhesive. The imaging element holder SH is formed with an opening SHk for exposing the imaging element IS. On a lower surface of the imaging element holder SH surrounding the opening SHk, an upwardly recessed portion including an open lower side is formed, and the imaging element IS is arranged in the recessed portion (not illustrated).

The substrate SB is a member for electrically connecting each of the module drive device MD and the lens drive device LD with a device outside the module drive device MD such as a controller CTR. In the illustrated example, the substrate SB is a flexible printed circuit board and includes an outer portion SB1 fixed to the module drive device MD, an inner portion SB2 fixed to the imaging element holder SH, and a connection portion SB3 connecting the outer portion SB1 and the inner portion SB2. The connection portion SB3 includes a left connection portion SB3L and a right connection portion SB3R. The imaging element IS is mounted on the inner portion SB2. The imaging element holder SH is a spacer member disposed between the inner portion SB2 and the movable-side cover member 4.

As illustrated in FIGS. 1 and 2, the module drive device MD includes a cover member 1 which is a part of a fixed-side member FB. The cover member 1 is configured to function as a housing HS covering members constituting the module drive device MD. In the illustrated example, the cover member 1 is formed of a non-magnetic metal such as an austenitic stainless steel. However, the cover member 1 may be formed of a magnetic metal.

Specifically, as illustrated in FIG. 2, the cover member 1 has an outer shape of a bottomless box shape defining a storage portion 1S. Also, the cover member 1 includes a side plate portion 1A having a rectangular cylindrical shape and a top plate portion 1B having a rectangular annular flat shape provided so as to be continuous with an upper end (end on the Z1 side) of the side plate portion 1A. A circular opening 1K is formed in the center of the top plate portion 1B. The side plate portion 1A includes a first side plate portion 1A1 to a fourth side plate portion 1A4. The first side plate portion 1A1 and the third side plate portion 1A3 face each other, and the second side plate portion 1A2 and the fourth side plate portion 1A4 face each other. The first side plate portion 1A1 and the third side plate portion 1A3 extend perpendicularly to the second side plate portion 1A2 and the fourth side plate portion 1A4.

As illustrated in FIGS. 2 and 3, the cover member 1 contains a module holder 2, a connection member 3, a metal member 5, a flexible metal member 6, a first metal member 7, a second metal member 8, a conductive member 9, a base member 18, a shape-memory alloy wire SA, and the like. The module holder 2 constitutes a movable-side member MB, and the base member 18 constitutes the fixed-side member FB. As illustrated in FIG. 1, the cover member 1 is bonded to the base member 18 and the substrate SB by an adhesive.

The module holder 2 is a member for holding the optical module OM and is formed by injection molding a synthetic resin such as liquid crystal polymer (LCP). In the illustrated example, the module holder 2 includes, as illustrated in FIG. 3, a side plate portion 2A having a rectangular cylindrical shape and a top plate portion 2B having a rectangular annular flat shape provided so as to be continuous with the upper end (end on the Z1 side) of the side plate portion 2A. A circular opening 2K is formed in the center of the top plate portion 2B. The side plate portion 2A includes a first side plate portion 2A1 to a fourth side plate portion 2A4. The first side plate portion 2A1 and the third side plate portion 2A3 face each other, and the second side plate portion 2A2 and the fourth side plate portion 2A4 face each other. The first side plate portion 2A1 and the third side plate portion 2A3 extend perpendicular to the second side plate portion 2A2 and the fourth side plate portion 2A4. In the illustrated example, an outer-peripheral surface of the side plate portion 4A of the movable-side cover member 4 of the optical module OM is configured to be bonded to an inner-peripheral surface of the side plate portion 2A of the module holder 2 with an adhesive.

The connection member 3 is a member for connecting the module holder 2 and the fixed-side member FB. Typically, the connection member 3 is a rectangular frame-shaped member arranged inside the base member 18 and outside the module holder 2, and includes a first extending portion 3E1 and a second extending portion 3E2 spaced from each other in an axial direction of a first axis AX1 and extending in an axial direction of a second axis AX2, and a third extending portion 3E3 and a fourth extending portion 3E4 spaced from each other in the axial direction of the second axis AX2 and extending in the axial direction of the first axis AX1. The first extending portion 3E1 to the fourth extending portion 3E4 constitute an extending portion 3E having a rectangular annular shape.

In the present embodiment, the connection member 3 is formed of a metal plate such as stainless steel or copper. The first extending portion 3E1 and the second extending portion 3E2 each include a first opposing plate portion 3P, the first opposing plate portions 3P facing each other in the axial direction (Y-axis direction) of the first axis AX1. The third extending portion 3E3 and the fourth extending portion 3E4 include a second opposing plate portion 30 whose plate surfaces face each other in the axial direction (X-axis direction) of the second axis AX2. Specifically, the first opposing plate portion 3P includes a first left opposing plate portion 3PL constituting the first extending portion 3E1 and a first right opposing plate portion 3PR constituting the second extending portion 3E2. The second opposing plate portion 30 includes a second front opposing plate portion 3QF constituting the third extending portion 3E3 and a second rear opposing plate portion 3QB constituting the fourth extending portion 3E4.

The connection member 3 is connected to the module holder 2 through a first metal member 7 partially embedded in the module holder 2, and is connected to the base member 18 through a second metal member 8 partially embedded in the base member 18.

The first metal member 7 is a member configured to be engaged with the connection member 3, and is partially embedded in the module holder 2. In the present embodiment, the first metal member 7 is a member formed of a metal such as stainless steel or copper, and includes a first left metal member 7L and a first right metal member 7R that are partially embedded in the module holder 2 by insert molding. The first left metal member 7L and the first right metal member 7R are integrally formed. However, the first left metal member 7L and the first right metal member 7R may be formed as separate and independent members.

The second metal member 8 is a member configured to be engaged with the connection member 3, and is partially embedded in the base member 18. In the present embodiment, the second metal member 8 is a member formed of a metal such as stainless steel or copper, and includes a second front metal member 8F and a second rear metal member 8B partially embedded in the base member 18 by insert molding. The second front metal member 8F and the second rear metal member 8B are formed as separate and independent members. However, the second front metal member 8F and the second rear metal member 8B may be integrally formed.

As illustrated in FIG. 3, the module drive device MD includes a first engagement part V1 provided such that the module holder 2 can rotate (swing) around the first axis AX1, and a second engagement part V2 provided such that the connection member 3 can rotate (swing) around the second axis AX2.

Specifically, the first engagement part V1 includes a first support-side engagement portion V1S provided at a central portion of the first extending portion 3E1 and the second extending portion 3E2 in the axial direction (X-axis direction) of the second axis AX2, and a first swing-side engagement portion V1T provided on the first metal member 7 so as to engage with the first support-side engagement portion V1S. This swinging mechanism realized by the connection member 3, the first metal member 7, and the second metal member 8 is also referred to as a gimbal-type swinging mechanism.

More specifically, the first support-side engagement portion V1S includes a first left support-side engagement portion V1SL provided at the central portion of the first extending portion 3E1, and a first right support-side engagement portion V1SR provided at the central portion of the second extending portion 3E2. The first swing-side engagement portion V1T includes a first left swing-side engagement portion V1TL provided on the first left metal member 7L so as to engage with the first left support-side engagement portion V1SL, and a first right swing-side engagement portion V1TR provided on the first right metal member 7R so as to engage with the first right support-side engagement portion V1SR.

Further, the second engagement part V2 includes a second swing-side engagement portion V2T provided at a central portion of the third extending portion 3E3 and the fourth extending portion 3E4 in the axial direction (Y-axis direction) of the first axis AX1, and a second support-side engagement portion V2S provided on the second metal member 8 so as to engage with the second swing-side engagement portion V2T.

More specifically, the second swing-side engagement portion V2T includes a second front swing-side engagement portion V2TF provided at a central portion of the third extending portion 3E3, and a second rear swing-side engagement portion V2TB provided at a central portion of the fourth extending portion 3E4. Further, the second support-side engagement portion V2S includes a second front support-side engagement portion V2SF provided on the second front metal member 8F so as to engage with the second front swing-side engagement portion V2TF, and a second rear support-side engagement portion V2SB provided on the second rear metal member 8B so as to engage with the second rear swing-side engagement portion V2TB.

A driver DM includes a shape-memory alloy wire SA as an example of a shape memory actuator. In the illustrated example, the shape-memory alloy wire SA includes a first wire SA1 to a fourth wire SA4 as illustrated in FIG. 3. A temperature of the shape-memory alloy wire SA rises when an electric current flows, and the shape-memory alloy wire SA contracts along with the rise of the temperature. The driver DM can swing the module holder 2 by utilizing the contraction of the shape-memory alloy wire SA.

The base member 18 is formed by injection molding using a synthetic resin such as a liquid crystal polymer (LCP). In the illustrated example, as illustrated in FIG. 3, the base member 18 has a substantially rectangular outline in top view and includes an opening 18K in the center.

Specifically, the base member 18 includes a base 18B having a rectangular annular shape arranged so as to surround the opening 18K having a rectangular shape. The base 18B includes a first base 18B1 to a fourth base 18B4.

The flexible metal member 6 is configured such that the fixed-side member FB (the base member 18) and the movable-side member MB (the module holder 2) can be connected. In the present embodiment, the flexible metal member 6 is a conductive connection member (plate spring) that connects the module holder 2 and the base member 18, and is formed, for example, of a metal plate mainly made of a copper alloy, a titanium-copper alloy (titanium-copper), or a copper-nickel alloy (nickel-tin copper).

Specifically, the flexible metal member 6 includes an inner portion 6N that is fixed to the module holder 2, an outer portion 6E that is fixed to the base member 18, and an elastic arm portion 6G that connects the inner portion 6N and the outer portion 6E. In the illustrated example, as illustrated in FIG. 3, the flexible metal member 6 includes a left flexible metal member 6L and a right flexible metal member 6R. The left flexible metal member 6L includes a first inner portion 6N1, a first outer portion 6E1, and a first elastic arm portion 6G1, and the right flexible metal member 6R includes a second inner portion 6N2, a second outer portion 6E2, and a second elastic arm portion 6G2. The first inner portion 6N1 is joined to a lower end surface of the second side plate portion 2A2 by caulking, the second inner portion 6N2 is joined to a lower end surface of the fourth side plate portion 2A4 by caulking, the first outer portion 6E1 is joined to an upper end surface of a second base 18B2 by caulking, and the second outer portion 6E2 is joined to an upper end surface of the fourth base 18B4 by caulking. The joining between the flexible metal member 6 and the module holder 2 or the base member 18 may be realized by an adhesive.

As described above, the flexible metal member 6 is configured to connect the lower surface of the side plate portion 2A of the module holder 2 and the upper surface of the base 18B of the base member 18. Specifically, the flexible metal member 6 is configured such that the left flexible metal member 6L connects the lower surface of the second side plate portion 2A2 and the upper surface of the second base 18B2, and the right flexible metal member 6R connects the lower surface of the fourth side plate portion 2A4 and the upper surface of the fourth base 18B4.

The metal member 5 is a member to which the end portion of the shape-memory alloy wire SA is fixed. In the present embodiment, the metal member 5 is a member made of a nonmagnetic metal such as phosphor bronze, and includes a fixed-side metal member 5F and a movable-side metal member 5M. The fixed-side metal member 5F is configured to be fixed to the base member 18, and the movable-side metal member 5M is configured to be fixed to the module holder 2.

More specifically, the fixed-side metal member 5F is also referred to as a fixed-side terminal plate and includes a first fixed-side metal member 5F1 to a fourth fixed-side metal member 5F4. The movable-side metal member 5M is also referred to as a movable-side terminal plate and includes a first movable-side metal member 5M1 and a second movable-side metal member 5M2.

Each of the first wire SA1 to the fourth wire SA4 has one end fixed to the fixed-side metal member 5F by crimping or welding, and the other end fixed to the movable-side metal member 5M by crimping or welding. Each of the first wire SA1 to the fourth wire SA4 has a linear shape along an outer surface of the side plate portion 2A of the module holder 2 when an electric current flows, and is configured such that the movable-side member MB (module holder 2) can swing with respect to the fixed-side member FB.

The conductive member 9 is a member provided such that an electric current can flow through the shape-memory alloy wire SA. In the illustrated example, the conductive member 9 is embedded in the base member 18. Specifically, the conductive member 9 includes a left conductive member 9L partially embedded in the second base 18B2 of the base member 18, and a right conductive member 9R partially embedded in the fourth base 18B4 of the base member 18.

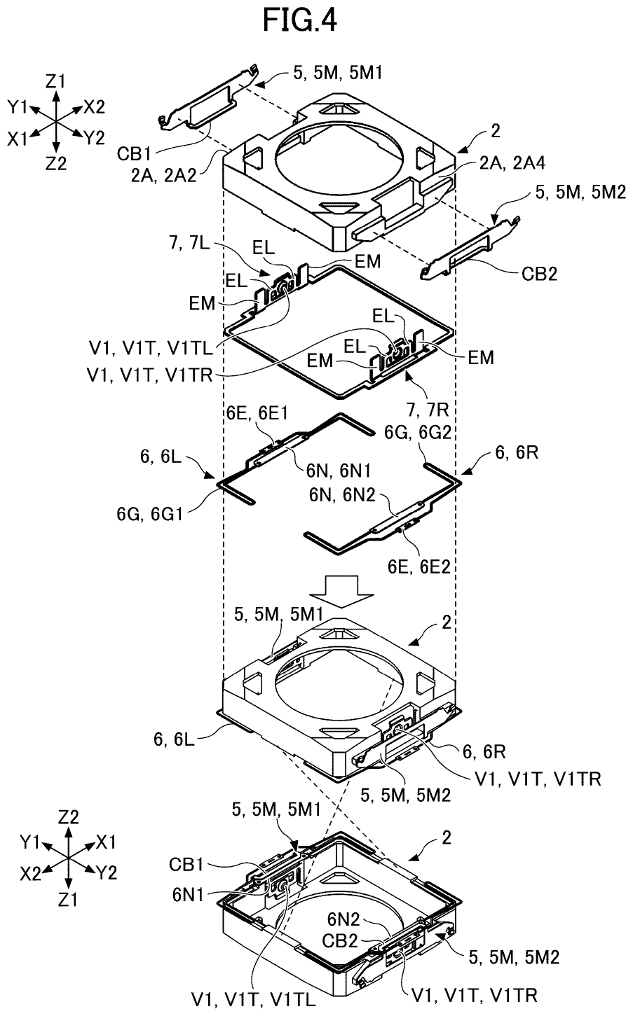

Next, a positional relationship between the module holder 2 and each of the movable-side metal member 5M, the flexible metal member 6, and the first metal member 7 will be described with reference to FIG. 4. FIG. 4 is a perspective view of the module holder 2, the movable-side metal member 5M, the flexible metal member 6, and the first metal member 7. More specifically, an upper figure (a figure above a block arrow) of FIG. 4 is a perspective view of the module holder 2, the movable-side metal member 5M, the flexible metal member 6, and the first metal member 7, in the separated state; a center figure of FIG. 4 (a figure below the block arrow) is an upper perspective view of the module holder 2 to which the movable-side metal member 5M and the flexible metal member 6 are attached and in which the first metal member 7 is embedded; and a lower figure of FIG. 4 is a lower perspective view of the module holder 2 to which the movable-side metal member 5M and the flexible metal member 6 are attached and in which the first metal member 7 is embedded.

In the illustrated example, the first movable-side metal member 5M1 is bonded to an outside surface (left side surface) of the second side plate portion 2A2 of the module holder 2 by an adhesive. Similarly, the second movable-side metal member 5M2 is bonded to an outside surface (right side surface) of the fourth side plate portion 2A4 of the module holder 2 by an adhesive.

The first movable-side metal member 5M1 includes a first fixing portion CB1 which is installed on and fixed to the first inner portion 6N1 of the left flexible metal member 6L on the lower surface of the second side plate portion 2A2 of the module holder 2. The first fixing portion CB1 is formed by bending a lower portion of the first movable-side metal member 5M1 to an L-shape. Similarly, the second movable-side metal member 5M2 includes a second fixing portion CB2 installed on and fixed to the second inner portion 6N2 of the right flexible metal member 6R on the lower surface of the fourth side plate portion 2A4 of the module holder 2. The second fixing portion CB2 is formed by bending the lower portion of the second movable-side metal member 5M2 to an L-shape.

The first metal member 7 includes an embedded portion EM embedded in the module holder 2, the first swing-side engagement portion V1T exposed from the module holder 2, and an elastic deformation portion EL that is elastically deformable, exposed from the module holder 2, and provided between the embedded portion EM and the first swing-side engagement portion V1T so as to connect the embedded portion EM and the first swing-side engagement portion V1T.

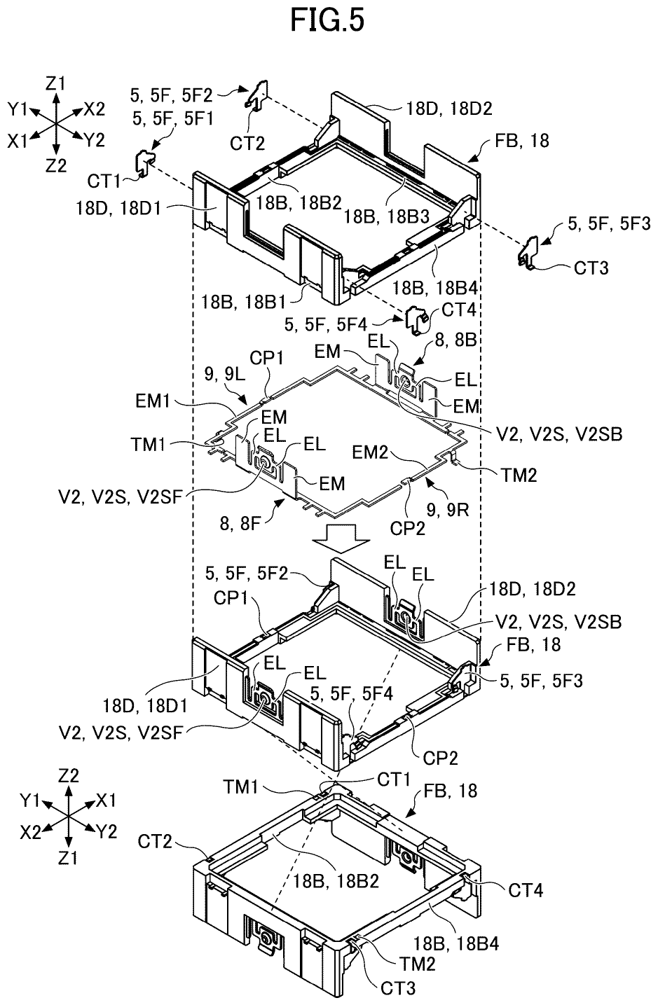

Next, a positional relationship between the base member 18 and each of the fixed-side metal member 5F, the second metal member 8, and the conductive member 9 will be described with reference to FIG. 5. FIG. 5 is a perspective view of the fixed-side metal member 5F, the second metal member 8, the conductive member 9, and the base member 18. More specifically, an upper figure (a figure above a block arrow) of FIG. 5 is a perspective view of the fixed-side metal member 5F, the second metal member 8, the conductive member 9, and the base member 18, in the separated state; a center figure of FIG. 5 (a figure below the block arrow) is an upper perspective view of the base member 18 to which the fixed-side metal member 5F is attached and in which the second metal member 8 and the conductive member 9 are embedded; and a lower figure of FIG. 5 is a lower perspective view of the base member 18 to which the fixed-side metal member 5F is attached and in which the second metal member 8 and the conductive member 9 are embedded.

In the illustrated example, the first fixed-side metal member 5F1 and the second fixed-side metal member 5F2 are joined to an outside surface (left side surface) of the second base 18B2 of the base member 18 by an adhesive. Similarly, the third fixed-side metal member 5F3 and the fourth fixed-side metal member 5F4 are joined to an outer surface (right side surface) of the fourth base 18B4 of the base member 18 by an adhesive.

The first fixed-side metal member 5F1 includes a first connection portion CT1 exposed to the lower surface of the base 18B of the base member 18 and fixed to the outer portion SB1 of the substrate SB by solder, conductive adhesive, or the like. Similarly, the second fixed-side metal member 5F2 includes a second connection portion CT2, the third fixed-side metal member 5F3 includes a third connection portion CT3, and the fourth fixed-side metal member 5F4 includes a fourth connection portion CT4.

The second metal member 8 includes an embedded portion EM embedded in the base member 18, a second support-side engagement portion V2S exposed from the base member 18, and an elastic deformation portion EL that is elastically deformable, exposed from the base member 18, and provided to connect the embedded portion EM and the second support-side engagement portion V2S between the embedded portion EM and the second support-side engagement portion V2S.

The conductive member 9 is a member for electrically connecting the flexible metal member 6 and the substrate SB. In the present embodiment, the conductive member 9 is formed of a metal such as copper. In the illustrated example, the conductive member 9 includes the left conductive member 9L for electrically connecting the left flexible metal member 6L and the substrate SB, and the right conductive member 9R for electrically connecting the right flexible metal member 6R and the substrate SB.

Specifically, the left conductive member 9L includes a first embedded portion EM1 embedded in the base member 18, a first bonding surface portion CP1 exposed on an upper surface of the second base 18B2, and a first terminal TM1 exposed on a lower surface of the second base 18B2. The right conductive member 9R includes a second embedded portion EM2 embedded in the base member 18, a second bonding surface portion CP2 exposed on an upper surface of the fourth base 18B4, and a second terminal TM2 exposed on a lower surface of the fourth base 18B4.

The base member 18 is configured to function as a wire support member for supporting one end of each of the first wire SA1 to fourth wire SA4. With this configuration, the movable-side member MB is supported by the first wire SA1 to fourth wire SA4 in a swingable state about the first axis AX1 and the second axis AX2, respectively.

A wall portion 18D is formed on the upper surface of the base member 18, which is a subject side surface (Z1 side surface). The wall portion 18D includes a first wall portion 18D1 extending upward from the first base 18B1 and a second wall portion 18D2 extending upward from the third base 18B3. The first wall portion 18D1 and the second wall portion 18D2 are arranged so as to face each other with the optical axis OA therebetween.

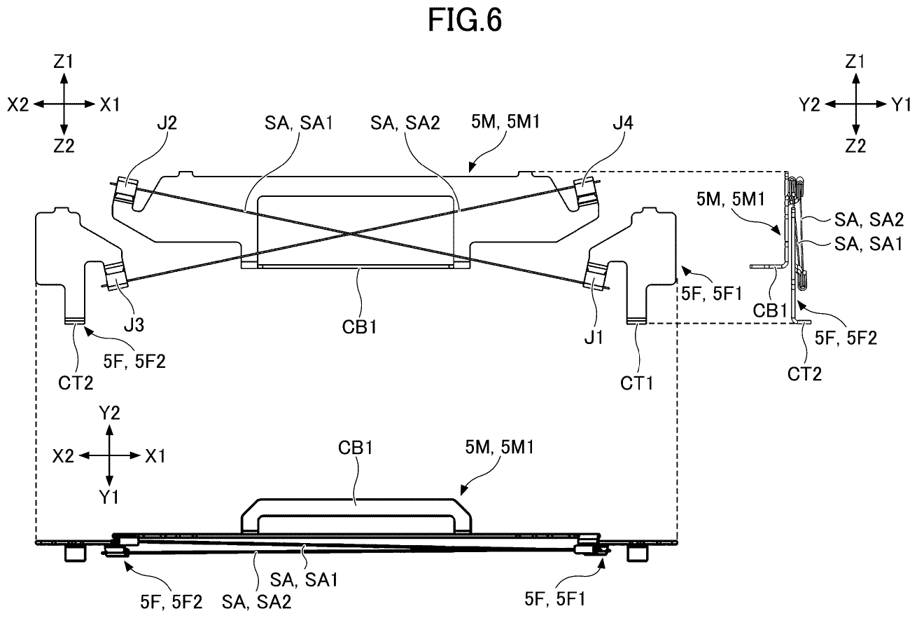

Next, referring to FIG. 6, the metal member 5 to which the shape-memory alloy wire SA is attached will be described. FIG. 6 is a three-side view (left side view, top view, and rear view) of the first fixed-side metal member 5F1, the second fixed-side metal member 5F2, the first movable-side metal member 5M1, the first wire SA1, and the second wire SA2. A positional relationship of each member as illustrated in FIG. 6 corresponds to the positional relationship when the module drive device MD is assembled and current is supplied to each of the first wire SA1 and the second wire SA2. In FIG. 6, other members are omitted for clarity. The following description referring to FIG. 6 relates to a combination of the first wire SA1 and the second wire SA2, but the same can be applied to a combination of the third wire SA3 and the fourth wire SA4.

Specifically, one end of the first wire SA1 is fixed to the first fixed-side metal member 5F1 at a holding portion J1 of the first fixed-side metal member 5F1, and the other end of the first wire SA1 is fixed to the first movable-side metal member 5M1 at a holding portion J2 on the rear side (X2 side) of the first movable-side metal member 5M1. Similarly, one end of the second wire SA2 is fixed to the second fixed-side metal member 5F2 at a holding portion J3 of the second fixed-side metal member 5F2, and the other end of the second wire SA2 is fixed to the first movable-side metal member 5M1 at a holding portion J4 on the front side (X1 side) of the first movable-side metal member 5M1.

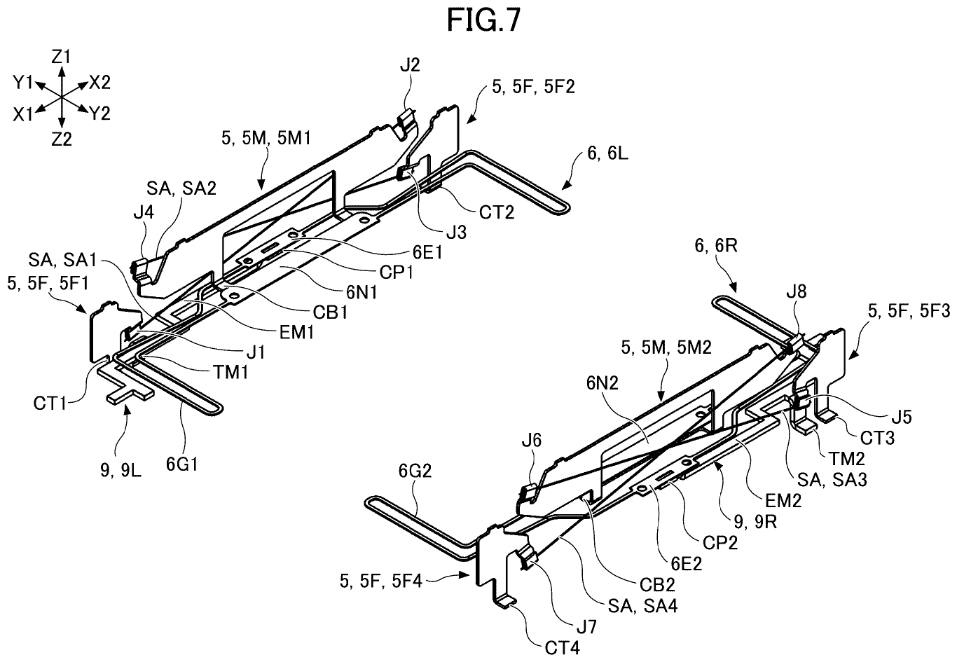

As illustrated in FIG. 7, one end of the third wire SA3 is fixed to the third fixed-side metal member 5F3 at a holding portion J5 of the third fixed-side metal member 5F3, and the other end of the third wire SA3 is fixed to the second movable-side metal member 5M2 at a holding portion J6 on the front side (X1 side) of the second movable-side metal member 5M2. Similarly, one end of the fourth wire SA4 is fixed to the fourth fixed-side metal member 5F4 at a holding portion J7 of the fourth fixed-side metal member 5F4, and the other end of the fourth wire SA4 is fixed to the second movable-side metal member 5M2 at a holding portion J8 on the rear side (X2 side) of the second movable-side metal member 5M2.

The holding portion J1 is formed by bending a part of the first fixed-side metal member 5F1. Specifically, a part of the first fixed-side metal member 5F1 is caulked with the end portion (one end) of the first wire SA1 sandwiched therebetween to form the holding portion J1. A coating on the end portion (one end) of the first wire SA1 is peeled off before being sandwiched by the holding portion J1. The end portion (one end) of the first wire SA1 is fixed to the holding portion J1 by welding. Thereafter, the end portion (one end) of the first wire SA1 may be protected by a protective resin. The same applies to the holding portions J2 to J8.

Further, the first wire SA1 and the second wire SA2 are arranged so as to be twisted with each other. That is, the first wire SA1 and the second wire SA2 are arranged so as not to contact each other (to be in non-contact). Specifically, as illustrated in the left side view of FIG. 6, the first wire SA1 and the second wire SA2 are arranged so as to intersect each other when viewed from the Y1 side (a direction perpendicular to a plate surface of the fixed-side metal member 5F). Similarly, as illustrated in FIG. 7, the third wire SA3 and the fourth wire SA4 are arranged so as to intersect each other when viewed from the Y2 side (a direction perpendicular to the plate surface of the fixed-side metal member 5F).

Next, a path of the current flowing through the shape-memory alloy wire SA will be described with reference to FIG. 7. FIG. 7 is a perspective view of the metal member 5, the flexible metal member 6, the conductive member 9, and the shape-memory alloy wire SA.

When the first connection portion CT1 of the first fixed-side metal member 5F1 is connected to a high potential and the first terminal TM1 of the left conductive member 9L is connected to a low potential, the current flows through the first connection portion CT1 to the first fixed-side metal member 5F1. Thereafter, the current passes through the holding portion J1, the first wire SA1, and the holding portion J2 and the first fixing portion CB1 of the first movable-side metal member 5M1. Thereafter, the current flows through the first inner portion 6N1, the first elastic arm portion 6G1, and the first outer portion 6E1 of the left flexible metal member 6L, through the first bonding surface portion CP1 of the left conductive member 9L, and through the first embedded portion EM1 of the left conductive member 9L to the first terminal TM1.

When the second connection portion CT2 of the second fixed-side metal member 5F2 is connected to a high potential and the first terminal TM1 of the left conductive member 9L is connected to a low potential, the current flows through the second connection portion CT2 to the second fixed-side metal member 5F2. Thereafter, the current flows through the holding portion J3, through the second wire SA2, and through the holding portion J4 and the first fixing portion CB1 of the first movable-side metal member 5M1. Thereafter, the current flows through the first inner portion 6N1, the first elastic arm portion 6G1, and the first outer portion 6E1 of the left flexible metal member 6L, through the first bonding surface portion CP1 of the left conductive member 9L, and through the first embedded portion EM1 of the left conductive member 9L to the first terminal TM1.

When the third connection portion CT3 of the third fixed-side metal member 5F3 is connected to a high potential and the second terminal TM2 of the right conductive member 9R is connected to a low potential, the current flows through the third connection portion CT3 to the third fixed-side metal member 5F3. Thereafter, the current flows through the holding portion J5, through the third wire SA3, and through the holding portion J6 and the second fixing portion CB2 of the second movable-side metal member 5M2. Thereafter, the current flows through the second inner portion 6N2, the second elastic arm portion 6G2, and the second outer portion 6E2, of the right flexible metal member 6R, through the second bonding surface portion CP2 of the right conductive member 9R, and through the second embedded portion EM2 of the right conductive member 9R to the second terminal TM2.

When the fourth connection portion CT4 of the fourth fixed-side metal member 5F4 is connected to a high potential and the second terminal TM2 of the right conductive member 9R is connected to a low potential, the current flows through the fourth connection portion CT4 to the fourth fixed-side metal member 5F4. Thereafter, the current flows through the holding portion J7, through the fourth wire SA4, and further through the holding portion J8 and the second fixing portion CB2 of the second movable-side metal member 5M2. Thereafter, the current flows through the second inner portion 6N2, the second elastic arm portion 6G2, and the second outer portion 6E2, of the right flexible metal member 6R, through the second bonding surface portion CP2 of the right conductive member 9R, and through the second embedded portion EM2 of the right conductive member 9R to the second terminal TM2.

When the first connection portion CT1 of the first fixed-side metal member 5F1 is connected to a high potential or when the second connection portion CT2 of the second fixed-side metal member 5F2 is connected to a high potential, the path of the current flowing from the first movable-side metal member 5M1 to the first terminal TM1 of the left conductive member 9L is the same. When the third connection portion CT3 of the third fixed-side metal member 5F3 is connected to a high potential or when the fourth connection portion CT4 of the fourth fixed-side metal member 5F4 is connected to a high potential, the path of the current flowing from the second movable-side metal member 5M2 to the second terminal TM2 of the right conductive member 9R is the same.

The controller CTR (see FIG. 1) located outside the module drive device MD as described above can individually control the shrinkage of the first wire SA1 to the fourth wire SA4 by controlling voltages applied to the connection portion (the first connection portion CT1 to the fourth connection portion CT4) of the fixed-side metal member 5F, the first terminal TM1 of the left conductive member 9L, and the second terminal TM2 of the right conductive member 9R. The controller CTR may be configured to detect resistance values of the first wire SA1 to the fourth wire SA4 and perform feedback control on shrinkage amounts of the first wire SA1 to the fourth wire SA4. In this case, the controller CTR can derive the position and orientation of the module holder 2 based on the resistance values of the first wire SA1 to the fourth wire SA4. The controller CTR may be disposed in the module drive device MD. The controller CTR may be a component of the module drive device MD.

The controller CTR may swing the module holder 2 around the first axis AX1 and the second axis AX2, for example, by utilizing a driving force generated by the contraction of the shape-memory alloy wire SA serving as the driver DM.

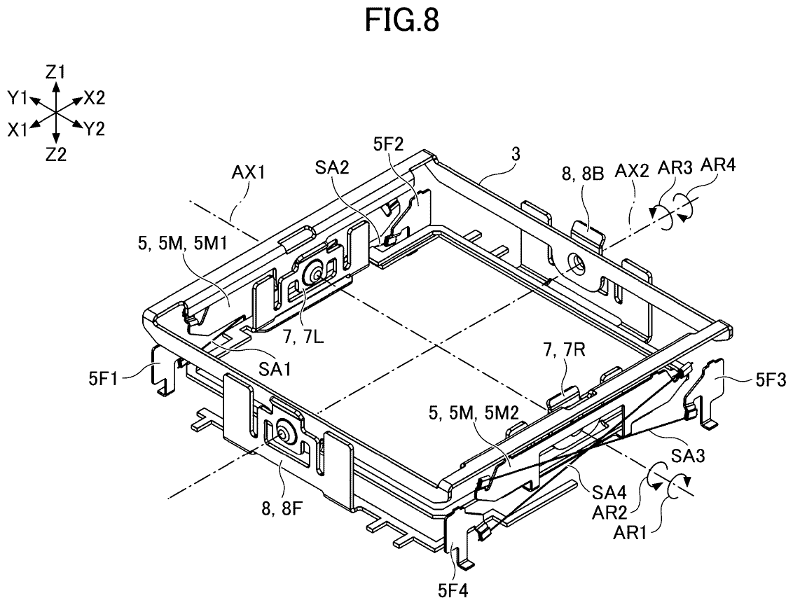

Next, the swing of the movable-side metal member 5M attached to the module holder 2 (not illustrated in FIG. 8) by the driver DM (shape-memory alloy wire SA) will be described with reference to FIG. 8. FIG. 8 is a perspective view of the connection member 3, the metal member 5, the first metal member 7, the second metal member 8, and the shape-memory alloy wire SA.

The controller CTR can swing the movable-side metal member 5M around the first axis AX1 in a direction indicated by an arrow AR1 by supplying electric currents to the first wire SA1 and the fourth wire SA4 and contracting the first wire SA1 and the fourth wire SA4, respectively.

Further, the controller CTR can swing the movable-side metal member 5M in a direction indicated by an arrow AR2 around a first axis AX1 by supplying electric currents to the second wire SA2 and the third wire SA3 to contract the second wire SA2 and the third wire SA3, respectively.

Further, the controller CTR can swing the movable-side metal member 5M around the second axis AX2 in a direction indicated by an arrow AR3 by supplying an electric current to the first wire SA1 and the second wire SA2 to contract the first wire SA1 and the second wire SA2, respectively.

Further, the controller CTR can swing the movable-side metal member 5M around the second axis AX2 in the direction indicated by an arrow AR4 by supplying electric currents to the third wire SA3 and the fourth wire SA4 to contract the third wire SA3 and the fourth wire SA4, respectively.

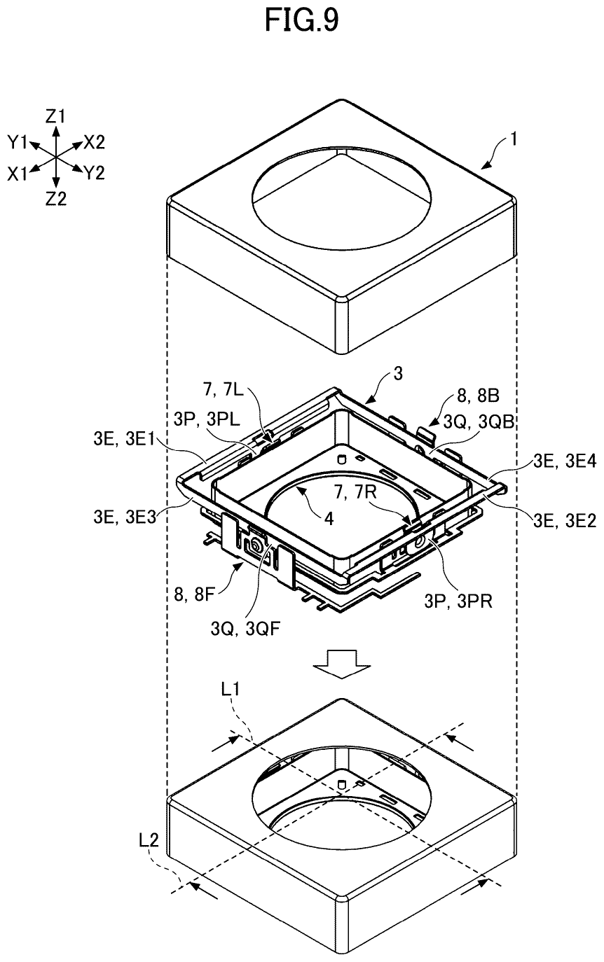

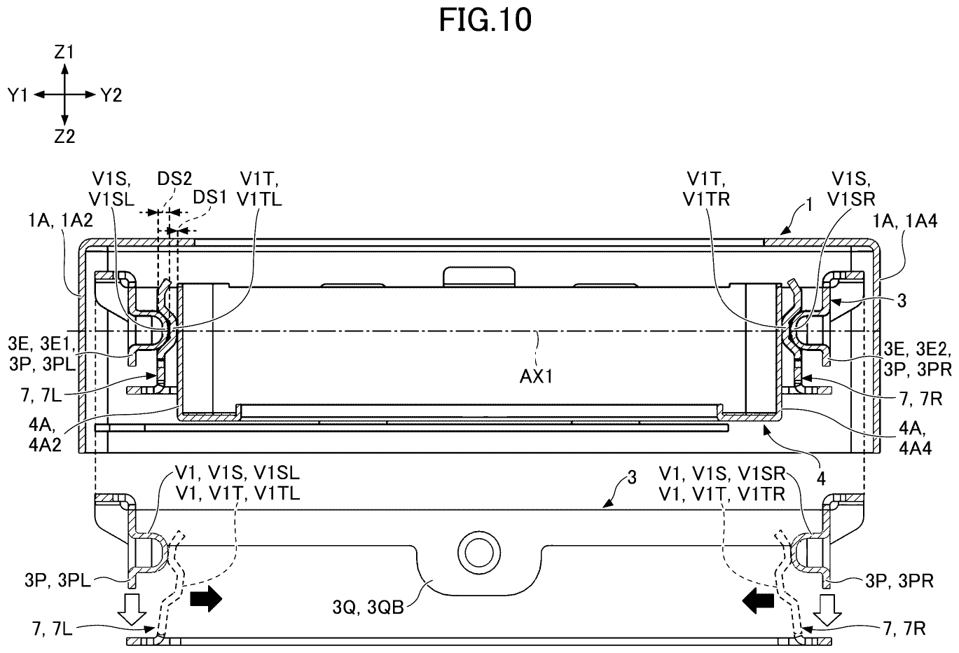

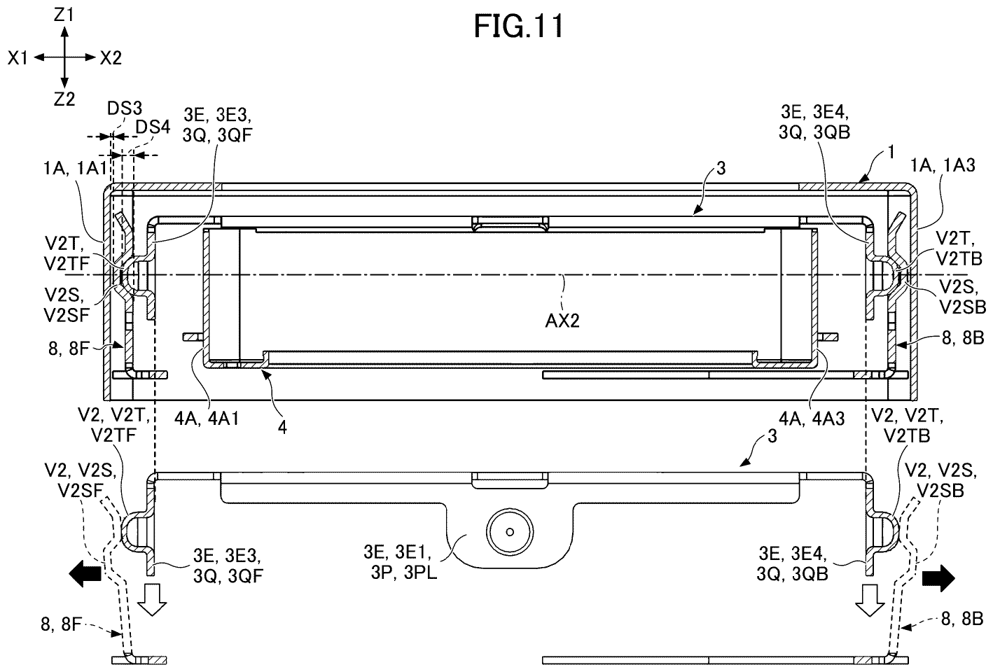

Next, with reference to FIGS. 9 to 11, a positional relationship of the cover member 1, the connection member 3, the movable-side cover member 4, the first metal member 7, and the second metal member 8 will be described. FIG. 9 is a perspective view of the cover member 1, the connection member 3, the movable-side cover member 4, the first metal member 7, and the second metal member 8. More specifically, an upper figure (a figure above a block arrow) of FIG. 9 illustrates a state in which the cover member 1 and a combination of the connection member 3, the movable-side cover member 4, the first metal member 7, and the second metal member 8 are separated, and a lower figure of FIG. 9 (a figure below the block arrow) illustrates a state in which the cover member 1, the connection member 3, the movable-side cover member 4, the first metal member 7, and the second metal member 8 are combined. FIGS. 10 and 11 are cross-sectional views of the cover member 1, the connection member 3, the movable-side cover member 4, the first metal member 7, and the second metal member 8. More specifically, an upper figure of FIG. 10 is a sectional view of each member in an imaginary plane parallel to a YZ plane including a broken line L1 in the lower figure of FIG. 9 when viewed from the X1 side. A lower figure of FIG. 10 is a sectional view of the connection member 3 and the first metal member 7 when the connection member 3 is engaged with the first metal member 7, and corresponds to the upper figure of FIG. 10. An upper figure of FIG. 11 is a sectional view of each member in an imaginary plane parallel to an XZ plane including a broken line L2 in the lower figure of FIG. 9 when viewed from the Y2 side. A lower figure of FIG. 11 is a sectional view of the connection member 3 and the second metal member 8 when the connection member 3 is engaged with the second metal member 8, and corresponds to the upper figure of FIG. 11. In FIGS. 9 to 11, other members constituting the module drive device MD are omitted for clarity.

As illustrated in the upper figure of FIG. 10, the first left support-side engagement portion V1SL provided in the central portion of the first left opposing plate portion 3PL constituting the first extending portion 3E1 of the connection member 3 is configured to engage with the first left swing-side engagement portion V1TL provided in the first left metal member 7L. Specifically, the first left support-side engagement portion V1SL formed so as to protrude inwardly (on the Y2 side) and form a convex curved surface is configured to engage with the first left swing-side engagement portion V1TL formed so as to recess inwardly (on the Y2 side) and form a concave curved surface.

Similarly, the first right support-side engagement portion V1SR provided in the central portion of the first right opposing plate portion 3PR constituting the second extending portion 3E2 of the connection member 3 is configured to engage with the first right swing-side engagement portion V1TR provided in the first right metal member 7R. Specifically, the first right support-side engagement portion V1SR, which protrudes inwardly (on the Y1 side) and is formed to form a convex curved surface, is configured to engage with the first right swing-side engagement portion V1TR, which is formed to recess inwardly (on the Y1 side) and form a concave curved surface.

Thus, the first left support-side engagement portion V1SL and the first left swing-side engagement portion V1TL form a snap-in structure, and the first right support-side engagement portion V1SR and the first right swing-side engagement portion V1TR form a snap-in structure.

When the connection member 3 and the first metal member 7, that are separated from each other, are pressed against the first metal member 7 from above as illustrated by white block arrows in the lower figure of FIG. 10 in order to engage with each other, the first metal member 7 is deformed (deflected) as illustrated by black block arrows in the lower figure of FIG. 10, and a distance between the first left metal member 7L and the first right metal member 7R is narrowed. Specifically, the first left metal member 7L is temporarily pressed inwardly (on the Y2 side) (deflected) by the elastic deformation of the substantially L-shaped elastic deformation portion EL (see FIG. 4), and the first right metal member 7R is temporarily pressed inwardly (on the Y1 side) (deflected) by the elastic deformation of the substantially L-shaped elastic deformation portion EL (see FIG. 4). A portion represented by a broken line in the lower figure of FIG. 10 represents a portion of the first metal member 7 deformed by contact with the connection member 3.

When the connection member 3 is pushed into the position as illustrated in the upper figure of FIG. 10, the first metal member 7 returns to the state before being pressed and narrowed, and the connection member 3 and the first metal member 7 are connected in a relatively swingable state around the first axis AX1.

Further, as illustrated in the upper figure of FIG. 10, when the movable-side cover member 4 is attached in a state where the connection member 3 and the first metal member 7 are connected, deformation of the first metal member 7 inward is limited by the movable-side cover member 4. Specifically, deformation of the first left metal member 7L inward (on the Y2 side) is limited by an outer surface of the second side plate portion 4A2 of the movable-side cover member 4, and deformation of the first right metal member 7R inward (on the Y1 side) is limited by an outer surface of the fourth side plate portion 4A4 of the movable-side cover member 4.

More specifically, the movable-side cover member 4 is arranged such that a dimension DS1 (zero in the illustrated example) between the outer surface of the second side plate portion 4A2 and the inner surface of the first left swing-side engagement portion V1TL is smaller than an engagement dimension DS2 between the first left support-side engagement portion V1SL and the first left swing-side engagement portion V1TL. The engagement dimension DS2 corresponds to, for example, a distance between an outer surface (on the Y1 side) of the first left metal member 7L (elastic deformation portion EL) and the inner surface (on the Y2 side) of the first left support-side engagement portion V1SL in a state where the connection member 3 and the first metal member 7 are connected. However, the engagement dimension DS2 may be a depth of a recess of the first left swing-side engagement portion V1TL in the Y-axis direction. In the illustrated example, the outer surface of the second side plate portion 4A2 and the inner surface of the first left swing-side engagement portion V1TL are in contact with each other, and the dimension DS1 is zero.

With this arrangement, even when the first metal member 7 is deformed by some kind of force such as an impact due to a fall, the movable-side cover member 4 can prevent the first metal member 7 from being narrowed inward to such an extent that the engagement between the connection member 3 and the first metal member 7 is released.

As illustrated in the upper figure of FIG. 11, the second front swing-side engagement portion V2TF provided in the central portion of the second front opposing plate portion 3QF constituting the third extending portion 3E3 of the connection member 3 is configured to engage with the second front support-side engagement portion V2SF provided in the second front metal member 8F. Specifically, the second front swing-side engagement portion V2TF formed so as to protrude outward (on the X1 side) to form a convex curved surface is configured to engage with the second front support-side engagement portion V2SF formed so as to recess outward (on the X1 side) to form a concave curved surface.

Similarly, the second rear swing-side engagement portion V2TB provided in the central portion of the second rear opposing plate portion 3QB constituting the fourth extending portion 3E4 of the connection member 3 is configured to engage with the second rear support-side engagement portion V2SB provided in the second rear metal member 8B. Specifically, the second rear swing-side engagement portion V2TB formed so as to protrude outward (on the X2 side) and form a convex curved surface is configured to engage with the second rear support-side engagement portion V2SB formed so as to recess outward (on the X2 side) and form a concave curved surface.

Thus, the second front swing-side engagement portion V2TF and the second front support-side engagement portion V2SF form a snap-in structure, and the second rear swing-side engagement portion V2TB and the second rear support-side engagement portion V2SB form a snap-in structure.

In order to engage the connection member 3 and the second metal member 8, that are separated from each other, when the connection member 3 is pressed against the second metal member 8 from above as illustrated by the white block arrows in the lower figure of FIG. 11, the second metal member 8 deforms (bends) as illustrated by the black block arrows in the lower figure of FIG. 11, and a distance between the second front metal member 8F and the second rear metal member 8B increases. Specifically, the second front metal member 8F is temporarily pushed outward (on the X1 side) (deflected) by elastic deformation of the elastic deformation portion EL that is substantially L-shaped (see FIG. 5), and the second rear metal member 8B is temporarily pushed outward (on the X2 side) (deflected) by elastic deformation of the substantially L-shaped elastic deformation portion EL (see FIG. 5). A portion represented by a broken line in the lower figure of FIG. 11 represents a portion of the second metal member 8 deformed by contact with the connection member 3.

When the connection member 3 is pushed into the position as illustrated in the upper figure of FIG. 11, the second metal member 8 returns to the state before being pushed and expanded, and the connection member 3 and the second metal member 8 are connected in a relatively swingable state around the second axis AX2.

As illustrated in the upper figure of FIG. 11, when the cover member 1 is attached with the connection member 3 and the second metal member 8 connected, deformation of the second metal member 8 toward the outside is limited by the cover member 1. Specifically, deformation of the second front metal member 8F toward the outside (X1 side) is limited by the inner surface of the first side plate portion 1A1 of the cover member 1, and deformation of the second rear metal member 8B toward the outside (X2 side) is limited by the inner surface of the third side plate portion 1A3 of the cover member 1.

More specifically, the cover member 1 is arranged such that a dimension DS3 between the inner surface of the first side plate portion 1A1 and the outer surface of the second front support-side engagement portion V2SF is smaller than an engagement dimension DS4 between the second front swing-side engagement portion V2TF and the second front support-side engagement portion V2SF. The engagement dimension DS4 corresponds to, for example, a distance between the inner surface (X2 side surface) of the second front metal member 8F (elastic deformation portion EL) and the outer surface (X1 side surface) of the second front swing-side engagement portion V2TF when the connection member 3 and the second metal member 8 are connected. However, the engagement dimension DS4 may be a depth of the recess of the second front support-side engagement portion V2SF in the X-axis direction.

With this arrangement, even when the second metal member 8 is deformed by some kind of force such as impact due to a drop, the cover member 1 can prevent the second metal member 8 from expanding outward to the extent that the engagement between the connection member 3 and the second metal member 8 is released.

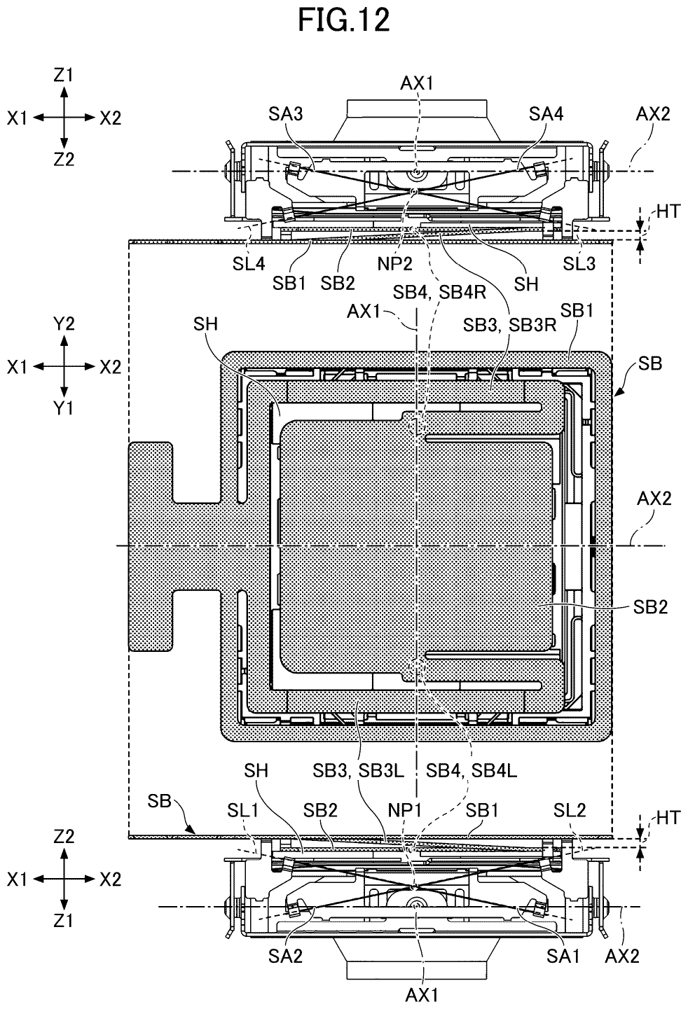

Next, the positional relationship between the substrate SB, the shape-memory alloy wire SA, and the first axis AX1 and the second axis AX2 will be described with reference to FIG. 12. FIG. 12 is a three-side view (right side view, bottom view, and left side view) of the optical module OM and the module drive device MD. In FIG. 12, the cover member 1 and the base member 18 are not illustrated for clarity, and the substrate SB is illustrated with a dot pattern.

In a lower figure (left side view) of FIG. 12, a first straight line SL1 represented by a broken line is a straight line connecting one end of the first wire SA1 and the other end of the first wire SA1 when viewed from the left side along the axial direction (Y-axis direction) of the first axis AX1. A second straight line SL2 represented by a broken line is a straight line connecting one end of the second wire SA2 and the other end of the second wire SA2. A first intersection point NP1 is an intersection point between the first straight line SL1 and the second straight line SL2, and exists at a position different from the first axis AX1, more specifically, at a position lower than the first axis AX1 (Z2 side).

In an upper figure (right side view) of FIG. 12, a third straight line SL3 represented by a broken line is a straight line connecting one end of the third wire SA3 and the other end of the third wire SA3 when viewed from the right along the axial direction (Y-axis direction) of the first axis AX1. A fourth straight line SL4 represented by a broken line is a straight line connecting one end of the fourth wire SA4 and the other end of the fourth wire SA4. A second intersection point NP2 is an intersection point between the third straight line SL3 and the fourth straight line SL4, and exists at a position different from the first axis AX1, more specifically, at a position lower than the first axis AX1 (Z2 side).

A fixed end SB4 is an inner end of the connection portion SB3 connecting the outer portion SB1 and the inner portion SB2 of the substrate SB which is a flexible printed board. In the illustrated example, the fixed end SB4 includes a left fixed end SB4L which is an inner end of the left connection portion SB3L, and a right fixed end SB4R which is an inner end of the right connection portion SB3R.

As illustrated in a center figure (bottom view) of FIG. 12, both the left fixed end SB4L and the right fixed end SB4R are arranged so as to be positioned on the first axis AX1 in the bottom view. That is, both the left fixed end SB4L and the right fixed end SB4R are arranged at positions closest to the first axis AX1. With this arrangement, for example, the substrate SB can suppress a force (torque around the first axis AX1) generated when the deformed connection portion SB3 tries to return to its original shape. The substrate SB is arranged such that a distance HT (difference in height) occurs between the outer portion SB1 and the inner portion SB2 in the optical axis direction (Z-axis direction). Therefore, the substrate SB is more likely to disperse the stress acting on the substrate SB when the module holder 2 swings than when the difference in height is not generated.

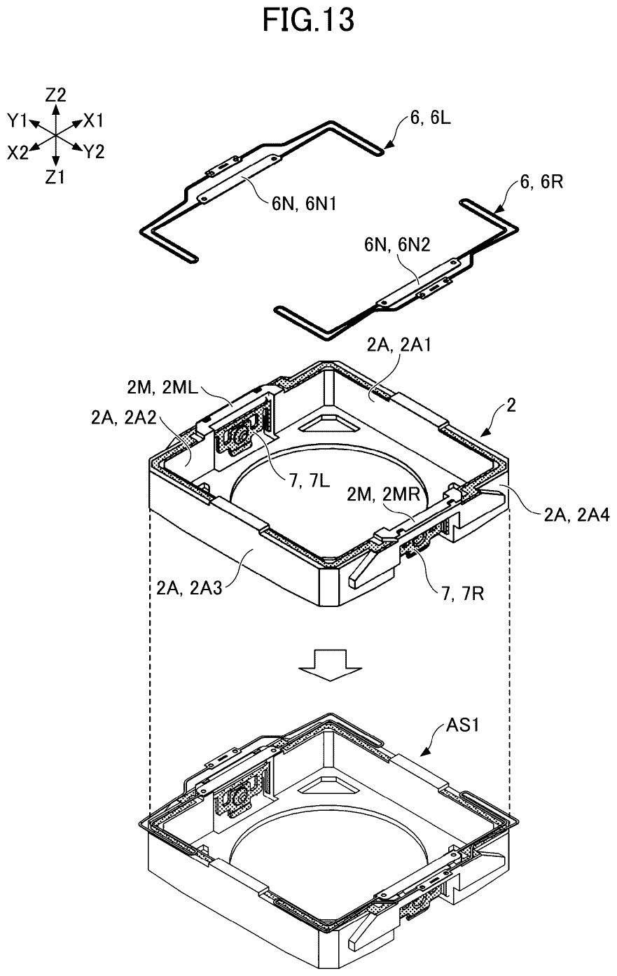

Next, a method of assembling the module drive device MD will be described with reference to FIGS. 13 to 20.

First, as illustrated in FIG. 13, the flexible metal member 6 is attached to the module holder 2 in which the first metal member 7 is embedded. FIG. 13 is a perspective view of a first assembly AS1 formed of the module holder 2, the flexible metal member 6, and the first metal member 7. Specifically, an upper figure (a figure above a block arrow) of FIG. 13 is a view before assembling the first assembly AS1, and a lower figure (a figure below the block arrow) of FIG. 13 is a view after assembling the first assembly AS1.

The flexible metal member 6 is fixed to a pedestal 2M formed at the lower end of the side plate portion 2A of the module holder 2. In the illustrated example, the first inner portion 6N1 of the left flexible metal member 6L is fixed to a left pedestal 2ML formed at the lower end of the second side plate portion 2A2 by caulking, and the second inner portion 6N2 of the right flexible metal member 6R is fixed to a right pedestal 2MR formed at the lower end of the fourth side plate portion 2A4 by caulking. The fixation by caulking is realized by crushing a projection (not illustrated) formed at the pedestal 2M while being inserted into a through hole formed at the inner portion 6N.

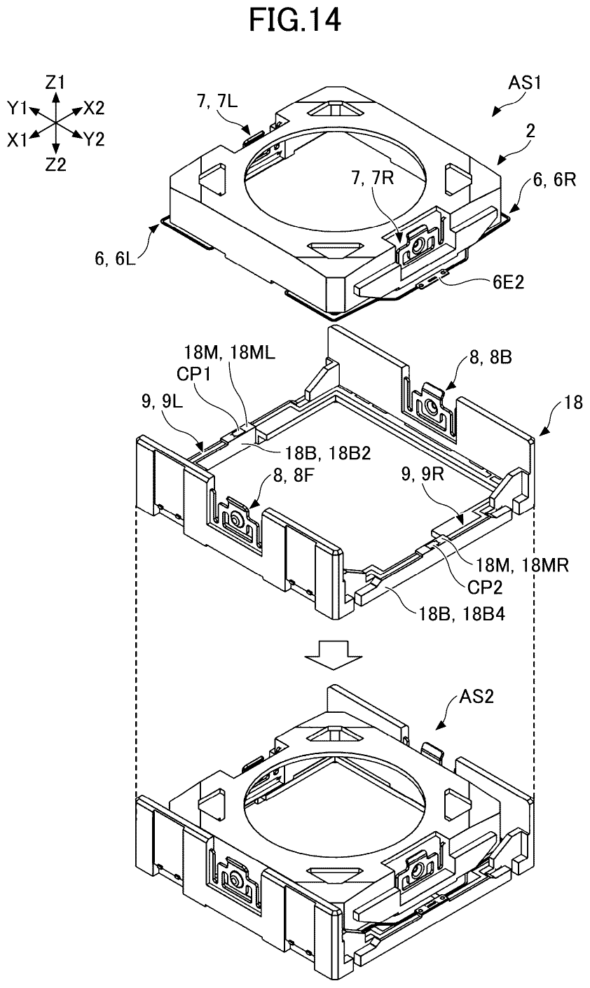

Thereafter, the first assembly AS1 is turned upside down as illustrated in FIG. 14, and attached to the base member 18 in which the second metal member 8 and the conductive member 9 are embedded. FIG. 14 is a perspective view of a second assembly AS2 formed of the first assembly AS1, the second metal member 8, the conductive member 9, and the base member 18. Specifically, an upper figure (a figure above a block arrow) of FIG. 14 is a view before assembly of the second assembly AS2, and a lower figure of FIG. 14 (a figure below the block arrow) is a view after the assembly of the second assembly AS2.

The flexible metal member 6 attached to the module holder 2 is fixed to a pedestal portion 18M formed at the upper end of the base 18B of the base member 18. In the illustrated example, the first outer portion 6E1 of the left flexible metal member 6L (cannot be seen in FIG. 14) is fixed to a left pedestal portion 18ML formed at the upper end of the second base 18B2 by caulking, and the second outer portion 6E2 of the right flexible metal member 6R is fixed to a right pedestal portion 18MR formed at the upper end of the fourth base 18B4 by caulking. The fixation by caulking is realized by crushing a projection (not illustrated) formed in the pedestal portion 18M while being inserted into a through hole formed in the outer portion 6E.

Further, the first outer portion 6E1 (cannot be seen in FIG. 14) of the left flexible metal member 6L is joined by welding to the first bonding surface portion CP1 of the left conductive member 9L exposed on the upper surface of the second base 18B2. Similarly, the second outer portion 6E2 of the right flexible metal member 6R is joined by welding to the second bonding surface portion CP2 of the right conductive member 9R exposed on the upper surface of the fourth base 18B4.

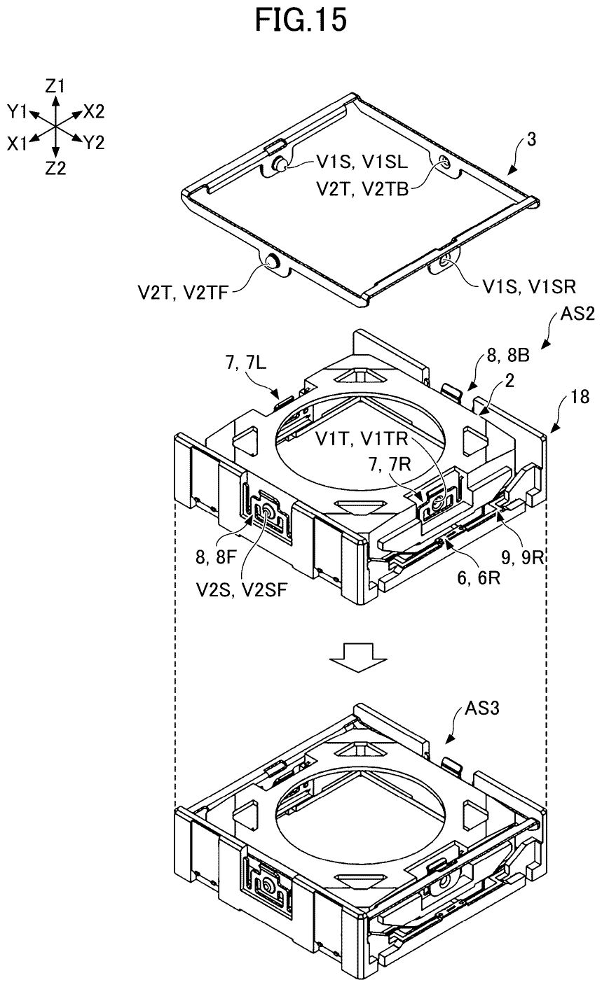

Thereafter, the connection member 3 is attached to the second assembly AS2 as illustrated in FIG. 15. FIG. 15 is a perspective view of a third assembly AS3 including the second assembly AS2 and the connection member 3. Specifically, an upper figure (a figure above a block arrow) of FIG. 15 is a view before the assembly of the third assembly AS3, and a lower figure of FIG. 15 (a figure below the block arrow) is a view after the assembly of the third assembly AS3.

The connection member 3 is simultaneously engaged with the first metal member 7 partially embedded in the module holder 2 and the second metal member 8 partially embedded in the base member 18 by press-fitting integration (snap stop). In the illustrated example, the connection member 3 is configured such that the first support-side engagement portion V1S is engaged with the first swing-side engagement portion V1T of the first metal member 7, and the second swing-side engagement portion V2T is engaged with the second support-side engagement portion V2S of the second metal member 8. When the connection member 3 is engaged, the first metal member 7 is configured to be temporarily deformed as illustrated by the broken line in the lower figure of FIG. 10, and the second metal member 8 is configured to be temporarily deformed as illustrated by the broken line in the lower figure of FIG. 11.

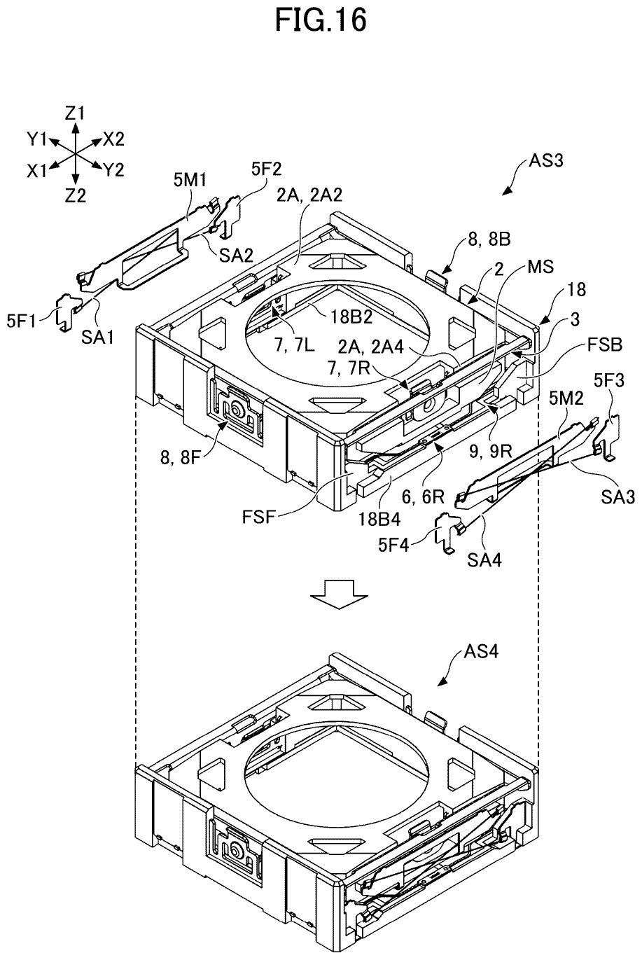

Then, as illustrated in FIG. 16, the metal member 5 to which the shape-memory alloy wire SA is fixed is attached to the third assembly AS3. FIG. 16 is a perspective view of a fourth assembly AS4 including the third assembly AS3, the metal member 5, and the shape-memory alloy wire SA. More specifically, an upper figure (a figure above a block arrow) of FIG. 16 is a view before the assembly of the fourth assembly AS4, and the lower figure of FIG. 16 (a figure below the block arrow) is a view after the assembly of the fourth assembly AS4.

The metal member 5 is bonded to each of the module holder 2 and the base member 18 by an adhesive. In the illustrated example, the fixed-side metal member 5F is bonded to the base member 18 by an adhesive, and the movable-side metal member 5M is bonded to the module holder 2 by an adhesive. More specifically, as illustrated in the upper figure of FIG. 16, the third fixed-side metal member 5F3 is bonded to a rear mounting surface FSB extending upward from the rear end of the fourth base 18B4 of the base member 18 by an adhesive, and the fourth fixed-side metal member 5F4 is bonded to a front mounting surface FSF extending upward from the front end of the fourth base 18B4 of the base member 18 by an adhesive. The second movable-side metal member 5M2 is bonded to a mounting surface MS formed on the right side surface of the fourth side plate portion 2A4 of the module holder 2 by an adhesive. Similarly, although not illustrated in the upper figure of FIG. 16, the first fixed-side metal member 5F1 is bonded to a front mounting surface FSF extending upward from the front end of the second base 18B2 of the base member 18 by an adhesive, and the second fixed-side metal member 5F2 is bonded to a rear mounting surface FSB extending upward from the rear end of the second base 18B2 of the base member 18 by an adhesive. The first movable-side metal member 5M1 is bonded to a mounting surface MS formed on the left side of the second side plate portion 2A2 of the module holder 2 by an adhesive.

Although the fixed-side metal member 5F and the movable-side metal member 5M are illustrated separately in the upper figure of FIG. 16, the fixed-side metal member 5F and the movable-side metal member 5M may be connected to each other by a connecting metal plate formed of the same material. In this case, the fixed-side metal member 5F and the movable-side metal member 5M are attached to the third assembly AS3 and then separated from the connecting metal plate.

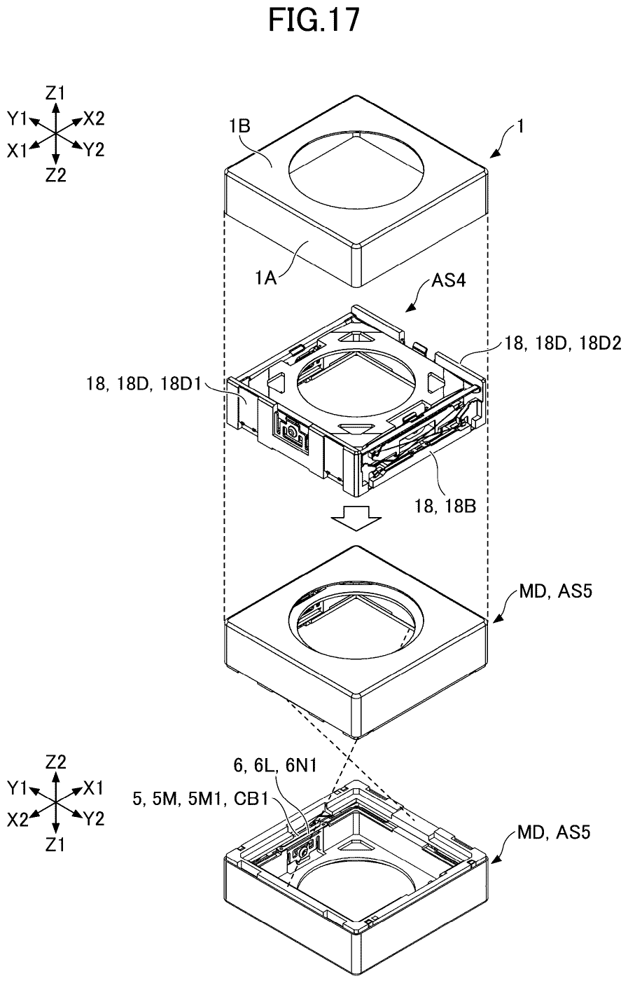

Thereafter, the cover member 1 is attached to the fourth assembly AS4 as illustrated in FIG. 17. FIG. 17 is a perspective view of a fifth assembly AS5 formed of the fourth assembly AS4 and the cover member 1. The fifth assembly AS5 corresponds to the module drive device MD. More specifically, an upper figure (a figure above a block arrow) of FIG. 17 is a view before assembly of the module drive device MD as the fifth assembly AS5, a center figure of FIG. 17 (a figure below the block arrow) is an upper perspective view of the assembled module drive device MD, and the lower figure of FIG. 17 is a lower perspective view of the assembled module drive device MD.

The cover member 1 is joined to the fourth assembly AS4 by an adhesive. In the illustrated example, the inner surfaces of the side plate portion 1A and the top plate portion 1B of the cover member 1 are joined to the outer surfaces of the base 18B and the wall portion 18D of the base member 18 by an adhesive.

Then, the module drive device MD is turned upside down as illustrated in the lower figure of FIG. 17. Then, the first fixing portion CB1 of the first movable-side metal member 5M1 and the first inner portion 6N1 of the left flexible metal member 6L are joined by welding, and the second fixing portion CB2 of the second movable-side metal member 5M2 (cannot be seen in FIG. 17) and the second inner portion 6N2 of the right flexible metal member 6R (cannot be seen in FIG. 17) are joined by welding.

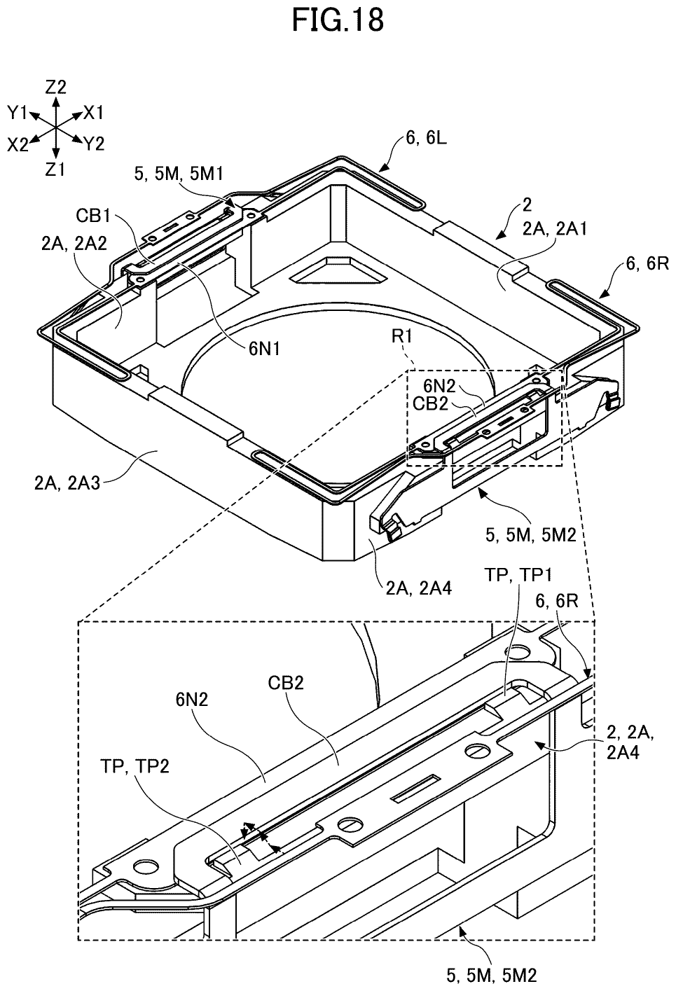

Now, joining of the movable-side metal member 5M and the flexible metal member 6 by welding will be described with reference to FIG. 18. FIG. 18 is a perspective view of the components of the module drive device MD that is turned upside down. Specifically, an upper figure of FIG. 18 is a perspective view of the module holder 2, the movable-side metal member 5M, and the flexible metal member 6, and a lower figure of FIG. 18 is an enlarged view of an area R1 enclosed by the broken line in the upper figure of FIG. 18. In FIG. 18, other members constituting the module drive device MD are omitted for clarity.

As illustrated in the lower figure of FIG. 18, a pair of projections TP projecting downward are formed at the lower end of the fourth side plate portion 2A4 of the module holder 2. In the illustrated example, the pair of projections TP includes a front projection TP1 and a rear projection TP2, and is configured to include a cross section forming a right-angle trapezoid in a cut plane parallel to the YZ plane.

Therefore, when the second movable-side metal member 5M2 is attached to the mounting surface MS (see the upper figure of FIG. 16) formed on the right side surface of the fourth side plate portion 2A4 from the Y2 side, the second fixing portion CB2 of the second movable-side metal member 5M2 moves inward (Y1 side) so as to pass over the projection TP. Specifically, as indicated by the dotted arrows in the lower figure of FIG. 18, the second fixing portion CB2 is deformed so as to contact a slope of the projection TP and spread downward (Z2 side), moves inward (Y1 side) along a lower end surface of the projection TP while remaining the deformed state, and returns to its original shape when the second fixing portion CB2 passes inward through the lower end surface of the projection TP. At this time, the second fixing portion CB2 contacts such that its upper surface (Z1 side surface) overlaps with a part of the lower surface (Z2 side surface) of the second inner portion 6N2 of the right flexible metal member 6R.

This configuration brings about an effect that the upper surface of the second fixing portion CB2 of the second movable-side metal member 5M2 and the lower surface of the second inner portion 6N2 of the right flexible metal member 6R are more securely adhered to each other, and the occurrence of a gap between the upper surface of the second fixing portion CB2 and the lower surface of the second inner portion 6N2 can be suppressed. Therefore, this configuration brings about an effect that the conductive connection by welding of the adhered portion can be stabilized. This configuration also brings about an effect that the second movable-side metal member 5M2 can be prevented from being separated from the fourth side plate portion 2A4 of the module holder 2 toward the outside (Y2 side). This is because the projection TP prevents the second fixing portion CB2 from moving toward the outside (Y2 side). The same applies to a conductive connection by welding between the upper surface of the first fixing portion CB1 of the first movable-side metal member 5M1 and the lower surface of the first inner portion 6N1 of the left flexible metal member 6L.

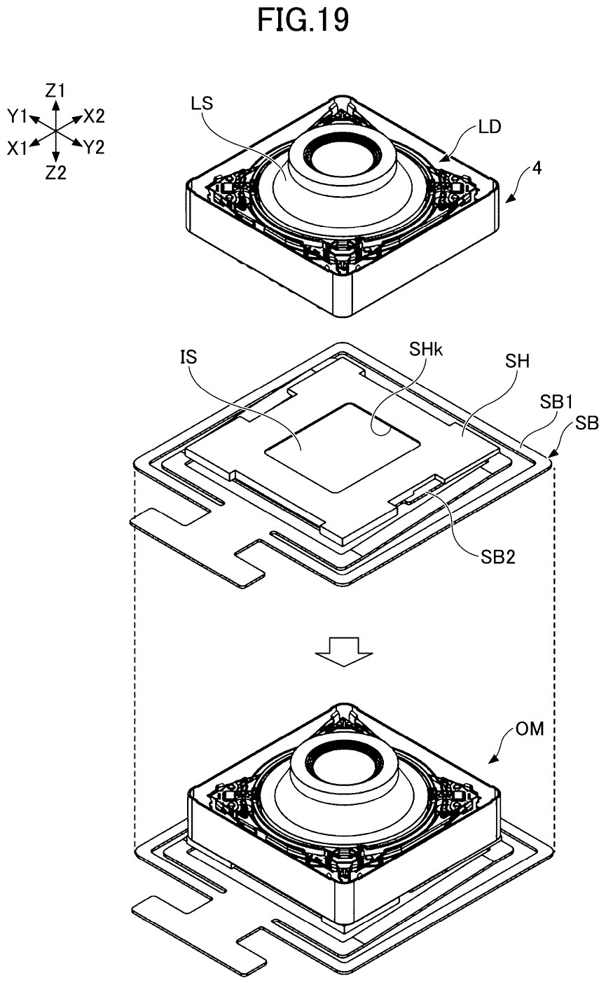

The optical module OM is assembled separately from the module drive device MD as illustrated in FIG. 19. FIG. 19 is a perspective view of the substrate SB to which the movable-side cover member 4 accommodating the lens body LS and the lens drive device LD and the imaging element holder SH accommodating and holding the imaging element IS are joined. Specifically, an upper figure (a figure above a block arrow) of FIG. 19 is a view before the optical module OM is assembled, and a lower figure of FIG. 19 (a figure below the block arrow) is a view after the optical module OM is assembled.

The optical module OM is assembled by bonding the lower surface of the movable-side cover member 4 to the upper surface of the imaging element holder SH with an adhesive. In the illustrated example, before the bonding, the lens body LS and the lens drive device LD are housed in the movable-side cover member 4, and the imaging element IS is fixed to the inner portion SB2 of the substrate SB with a conductive adhesive or solder. Further, the imaging element holder SH houses the imaging element IS with the imaging surface of the imaging element IS exposed from the opening SHk, and is bonded to the upper surface of the inner portion SB2 of the substrate SB with an adhesive. At least a part of the outer shape of the imaging element IS is held by the imaging element holder SH.

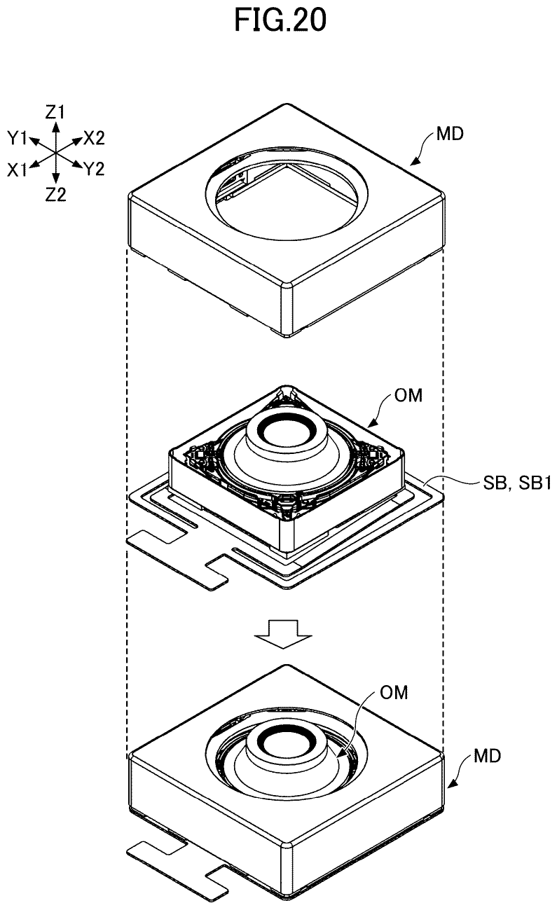

Thereafter, the optical module OM is attached to the module drive device MD as illustrated in FIG. 20. FIG. 20 is a perspective view of the module drive device MD and the optical module OM. Specifically, an upper figure (a figure above a block arrow) of FIG. 20 is a view before the optical module OM is attached to the module drive device MD, and a lower figure of FIG. 20 (a figure below the block arrow) is a view after the optical module OM is attached to the module drive device MD.

In the illustrated example, the optical module OM and the module drive device MD are bonded by an adhesive. The bonding between the optical module OM and the module drive device MD includes bonding of each of the first connection portion CT1 to the fourth connection portion CT4 exposed on the lower surface of the base member 18, the first terminal TM1, and the second terminal TM2, to a conductor pattern formed on the upper surface of the outer portion SB1 of the substrate SB by a conductive adhesive, solder, or the like, as illustrated in FIG. 5.

As described above, as illustrated in FIG. 2, the module drive device MD according to one embodiment of the present disclosure is provided with the module holder 2 configured to hold an optical module OM including the lens body LS and the imaging element IS, the connection member 3 connected to the module holder 2 such that the module holder 2 can swing around the first axis AX1 intersecting the optical axis direction (Z-axis direction), the fixed-side member FB (base member 18) connected to the connection member 3 such that the connection member 3 can swing around the second axis AX2 intersecting the optical axis direction and perpendicular to the axial direction (Y-axis direction) of the first axis AX1, and the driver DM that moves the module holder 2 relative to the fixed-side member FB such that the optical axis OA of the lens body LS is inclined.

Further, as illustrated in FIG. 3, the module drive device MD includes the first engagement part V1 provided such that the module holder 2 can swing around the first axis AX1, and the second engagement part V2 provided such that the connection member 3 can swing around the second axis AX2.

Further, as illustrated in FIG. 3, the connection member 3 is formed of a frame-shaped metal configured to dispose the module holder 2 inside, and includes the first extending portion 3E1 and the second extending portion 3E2 spaced from each other in the axial direction of the first axis AX1 and extending in the axial direction (X-axis direction) of the second axis AX2, and includes the third extending portion 3E3 and the fourth extending portion 3E4 spaced from each other in the axial direction of the second axis AX2 and extending in the axial direction of the first axis AX1.

The first engagement part V1 includes the first support-side engagement portion V1S provided at the center of each of the first extending portion 3E1 and the second extending portion 3E2 in the axial direction of the second axis AX2, and the first swing-side engagement portion V1T provided in the module holder 2 so as to engage with the first support-side engagement portion V1S.

Further, the second engagement part V2 includes the second swing-side engagement portion V2T provided at the center of each of the third extending portion 3E3 and the fourth extending portion 3E4 in the axial direction of the first axis AX1, and the second support-side engagement portion V2S provided on the fixed-side member FB (base member 18) so as to engage with the second swing-side engagement portion V2T.

In the illustrated example, the first engagement part V1 is configured such that the first support-side engagement portion V1S projects inward to form a convex curved surface, and the first swing-side engagement portion V1T recesses inward to form a concave curved surface, but the first support-side engagement portion VIS may recess outward to form a concave curved surface, and the first swing-side engagement portion V1T may project outward to form a convex curved surface. The same applies to the second engagement part V2.

In this configuration, since the first engagement part V1 and the second engagement part V2 are both provided at the central portion of the extending portion 3E, compared with a case where the first engagement part V1 and the second engagement part V2 are provided at the end portion of the extending portion 3E, the corner portion of the module holder 2 can be prevented from being elevated when the module holder 2 swings. Therefore, this configuration makes it possible to reduce the space for accommodating the module holder 2, and in turn, it makes it possible to reduce the size (height) of the module drive device MD.

In addition, since the connection member 3 is made of metal, this configuration makes it possible to reduce the size of the module drive device MD compared with a case where the connection member 3 is made of a synthetic resin or the like.

The first swing-side engagement portion V1T may be formed of the first metal member 7 (see FIG. 4) made of a metal plate, and the second support-side engagement portion V2S may be formed of the second metal member 8 (see FIG. 5) made of a metal plate.

This configuration brings about an effect that the durability of each of the first engagement part V1 and the second engagement part V2 can be enhanced as compared with a case where each of the first swing-side engagement portion V1T and the second support-side engagement portion V2S is formed of a synthetic resin or the like.

Further, as illustrated in FIG. 4, the first metal member 7 may include an embedded portion EM embedded in the module holder 2 made of a synthetic resin, the first swing-side engagement portion V1T exposed from the module holder 2, and an elastic deformation portion EL that is elastically deformable, exposed from the module holder 2, and provided to connect the embedded portion EM and the first swing-side engagement portion V1T between the embedded portion EM and the first swing-side engagement portion V1T. Further, as illustrated in FIG. 5, the fixed-side member FB may include the base member 18 made of a synthetic resin and the second metal member 8 embedded in the base member 18. The second metal member 8 may include the embedded portion EM embedded in the base member 18, the second support-side engagement portion V2S exposed from the base member 18, and the elastic deformation portion EL that is elastically deformable, exposed from the base member 18, and provided to connect the embedded portion EM and the second support-side engagement portion V2S between the embedded portion EM and the second support-side engagement portion V2S.

This configuration brings about the effect of facilitating the assembly of the connection member 3 to each of the first metal member 7 and the second metal member 8, since a snap stop using the elastic deformation portion EL can be utilized. As a result, this configuration brings about an effect of increasing the productivity of the module drive device MD or reducing the manufacturing cost of the module drive device MD. In addition, since the snap-in components (first metal member 7 including the first swing-side engagement portion V1T, and second metal member 8 including a second support-side engagement portion V2S) are embedded in the module holder 2 or in the base member 18 by insert molding, the number of components is reduced, and consequently, the number of steps in assembling the module drive device MD is reduced.

As illustrated in FIG. 2, the base member 18 may include a pair of wall portions 18D disposed outside the connection member 3 and facing each other while being spaced apart in the axial direction (X-axis direction) of the second axis AX2 across the module holder 2. The second metal member 8 may be embedded in each of the wall portions 18D as illustrated in FIG. 5. The fixed-side member FB may also include a cover member 1 constituting the housing HS together with the base member 18 as illustrated in FIG. 1. The cover member 1 may also include the side plate portion 1A disposed outside the wall portion 18D as illustrated in FIG. 2. The side plate portion 1A, the second swing-side engagement portion V2T, and the second support-side engagement portion V2S may be arranged such that the engagement dimension DS4 between the second swing-side engagement portion V2T and the second support-side engagement portion V2S in the axial direction (X-axis direction) of the second axis AX2 is larger than the dimension DS3 between the side plate portion 1A and the second support-side engagement portion V2S, as illustrated in FIG. 11. That is, one of the second swing-side engagement portion V2T or the second support-side engagement portion V2S is formed in a convex shape along the axial direction (X-axis direction) of the second axis AX2, and the other is formed in a concave shape along the axial direction of the second axis AX2. The engagement dimension DS4 in the axial direction of the second axis AX2, between the second swing-side engagement portion V2T and the second support-side engagement portion V2S, being formed by interlocking the concave portions and the convex portions, is formed so as to be larger than the dimension DS3 between the side plate portion 1A and the second support-side engagement portion V2S. In the example as illustrated in FIG. 11, the second swing-side engagement portion V2T is formed in a convex shape toward the second support-side engagement portion V2S along the axial direction of the second axis AX2, and the second support-side engagement portion V2S is formed in a concave shape along the axial direction of the second axis AX2. However, the second support-side engagement portion V2S may be formed in a convex shape toward the second swing-side engagement portion V2T along the axial direction of the second axis AX2, and the second swing-side engagement portion V2T may be formed in a concave shape along the axial direction of the second axis AX2.

This configuration brings about an effect of suppressing disengagement of the engagement (engagement between the second swing-side engagement portion V2T and the second support-side engagement portion V2S) by the snap-in structure. This is because, in this configuration, deformation of the second metal member 8 is limited by the side plate portion 1A of the cover member 1 even when a strong impact is applied to the module drive device MD due to a drop or the like.

The connection member 3 may be formed of a metal plate. As illustrated in FIG. 3, the first extending portion 3E1 and the second extending portion 3E2 may each include a first opposing plate portion 3P, the first opposing plate portions 3P facing each other in the axial direction (Y-axis direction) of the first axis AX1. The first support-side engagement portion V1S may be formed in a convex curved shape in the first opposing plate portion 3P such that the inner surface of the first opposing plate portion 3P projects inward along the axial direction (Y-axis direction) of the first axis AX1. The first swing-side engagement portion V1T may be formed in a concave curved shape such that the outer surface of the first metal member 7 is recessed inward along the axial direction (Y-axis direction) of the first axis AX1. As illustrated in FIG. 10, the first swing-side engagement portion V1T and the first support-side engagement portion V1S may be arranged such that the engagement dimension DS2 between the first swing-side engagement portion V1T and the first support-side engagement portion V1S in the axial direction (Y-axis direction) of the first axis AX1 is larger than the dimension DS1 between the inner surface of the portion where the first swing-side engagement portion V1T of the first metal member 7 is formed (the inner surface of the convex curved portion on the opposite side of the concave curved portion) and the outer surface of the optical module OM held by the module holder 2.

This configuration brings about an effect that disengagement of the engagement by the snap-in structure (engagement between the first swing-side engagement portion V1T and the first support-side engagement portion V1S) can be suppressed. This is because, in this configuration, deformation of the first metal member 7 is limited by the optical module OM (side plate portion 4A of the movable-side cover member 4) even when a strong impact is applied to the module drive device MD due to a drop or the like.

The connection member 3 may be formed of a metal plate including a plurality of bent portions BD, as illustrated in FIG. 3. In this case, the first extending portion 3E1 and the second extending portion 3E2 may each include a first opposing plate portion 3P, the first opposing plate portions 3P facing each other in the axial direction (Y-axis direction) of the first axis AX1. The first support-side engagement portion V1S may be formed in the first opposing plate portion 3P. The third extending portion 3E3 and the fourth extending portion 3E4 may include a second opposing plate portion 30 whose plate surfaces face each other in the axial direction (X-axis direction) of the second axis AX2. The second swing-side engagement portion V2T may be formed in the second opposing plate portion 3Q. The first support-side engagement portion V1S and the second swing-side engagement portion V2T may project in the same direction (Z1 direction) in a state where the bent portions BD are unbent such that the plate surfaces of the first opposing plate portion 3P and the second opposing plate portion 3Q are parallel to the same imaginary plane parallel to the XY plane, that is, a state before the metal plate constituting the connection member 3 is bent.

With this configuration, since the protruding direction (pressing direction) when the first support-side engagement portion V1S and the second swing-side engagement portion V2T are formed on the metal plate is the same, processing of the connection member 3 is facilitated as compared with the case where the protruding direction (pressing direction) is different.

Further, as illustrated in FIG. 3, the driver DM may include a plurality of shape-memory alloy wires SA. In this case, the shape-memory alloy wires SA may be provided at two positions separated in the axial direction (Y-axis direction) of the first axis AX1 across the optical module OM.

This configuration brings about an effect that downsizing can be realized as compared with a voice coil motor type driver including a magnet and a coil. Also, this configuration brings about an effect that interference between the shape-memory alloy wires SA and the second swing-side engagement portion V2T and the second support-side engagement portion V2S can be suppressed because the shape-memory alloy wires SA are arranged at a position different from the engagement (connection) position between the second swing-side engagement portion V2T and the second support-side engagement portion V2S. Also, this configuration brings about an effect that since a larger driving force can be realized as compared with the voice coil motor type driver, routing of the substrate SB as a flexible printed circuit board becomes easy, and the module drive device MD can be down-sized.

As illustrated in FIG. 3, the shape-memory alloy wire SA may include the first wire SA1 and the second wire SA2 arranged at one position in the axial direction (Y-axis direction) of the first axis AX1, and the third wire SA3 and the fourth wire SA4 arranged at the other position in the axial direction (Y-axis direction) of the first axis AX1. In this case, each of the first wire SA1, the second wire SA2, the third wire SA3, and the fourth wire SA4 may have one end fixed to the fixed-side metal member 5F provided on the fixed-side member FB (base member 18), and the other end fixed to the movable-side metal member 5M provided on the movable-side member MB including the module holder 2. When viewed along the axial direction (Y-axis direction) of the first axis AX1, the first wire SA1 and the second wire SA2 may intersect each other, and the third wire SA3 and the fourth wire SA4 may intersect each other.

This configuration brings about an effect that the swing operation around the first axis AX1 and the swing operation around the second axis AX2 can be realized. In addition, this configuration brings about an effect that power consumption can be reduced, and the electric circuit for driving the driver DM can be simplified, as compared with the configuration in which the swing operation around two axes is realized using five or more shape-memory alloy wires SA. The simplification of the electric circuit also brings about an effect that noise countermeasures can be easily taken when the expansion and contraction of the shape-memory alloy wires SA are realized by PWM control. In the illustrated example, the electric circuit for driving the driver DM is completed on one side (upper side) of the base member 18, as illustrated in FIG. 7. In addition, this configuration brings about an effect that, since the number of the flexible metal members 6 can be reduced, the driving force required for the swing operation can be reduced as compared with the configuration in which the swing operation around two axes is realized by using five or more shape-memory alloy wires SA. In addition, this configuration brings about an effect that the amount of expansion and contraction of the shape-memory alloy wires SA can be reduced, as compared with the case in which the shape-memory alloy wires are used in a module drive device having a large size, because the module drive device MD is reduced in size (reduced in height), and consequently, an effect that the service life of the shape-memory alloy wires SA can be extended can be realized.

As illustrated in the lower figure of FIG. 12, when viewed along the axial direction (Y-axis direction) of the first axis AX1, the first intersection point NP1 between the first straight line SL1 connecting one end of the first wire SA1 and the other end of the first wire SA1 and the second straight line SL2 connecting one end of the second wire SA2 and the other end of the second wire SA2 may be at a position different from the first axis AX1. As illustrated in the upper figure of FIG. 12, when viewed along the axial direction (Y-axis direction) of the first axis AX1, the second intersection point NP2 between the third straight line SL3 connecting one end of the third wire SA3 and the other end of the third wire SA3 and the fourth straight line SL4 connecting one end of the fourth wire SA4 and the other end of the fourth wire SA4 may be at a position different from the first axis AX1. In the present embodiment, the first intersection point NP1 and the second intersection point NP2 are on the same side (e.g., the lower side, which is the Z2 side) as seen from the first axis AX1 in the optical axis direction.

This configuration brings about an effect that the swinging operation of the module holder 2 can be ensured more reliably than when the positions of the intersections (the first intersection point NP1 and the second intersection point NP2) coincide with the positions of the first axis AX1. The configuration in which the positions of the intersections coincide with the positions of the first axis AX1 makes the swinging direction unstable, that is, the shape-memory alloy wire SA can swing in either of the two swinging directions when contracted.

The other end of the first wire SA1 and the other end of the second wire SA2 may be electrically connected through the first movable-side metal member 5M1 as illustrated in FIG. 7. The other end of the third wire SA3 and the other end of the fourth wire SA4 may be electrically connected through the second movable-side metal member 5M2.

This configuration brings about an effect that an energization path of the shape-memory alloy wires SA can be easily secured, as compared with the configuration in which the two shape-memory alloy wires SA are not conducted through the movable-side metal member 5M.

The module drive device described above can be downsized.

The preferred embodiments of the present invention have been described in detail. However, the present invention is not limited to the embodiments described above. Various modifications, substitutions, and the like can be applied to the embodiments described above without departing from the scope of the present invention. Further, each of the features described with reference to the embodiments described above may be suitably combined as long as there is no technical conflict.

What is claimed is:

1. A module drive device, comprising:
a module holder configured to hold an optical module including a lens body and an imaging device;
a connection member connected to the module holder such that the module holder is swingable around a first axis intersecting an optical axis direction;
a fixed-side member connected to the connection member such that the connection member is swingable around a second axis perpendicular to an axial direction of the first axis;
a driver that moves the module holder with respect to the fixed-side member;
a first engagement part provided such that the module holder is swingable around the first axis; and
a second engagement part provided such that the connection member is swingable around the second axis, wherein
the connection member is formed of a frame-shaped metal so that the module holder is arrangeable therein, and
the connection member includes
a first extending portion and a second extending portion that are separated from each other in the axial direction of the first axis and extend in an axial direction of the second axis, and
a third extending portion and a fourth extending portion that are separated from each other in the axial direction of the second axis and extend in the axial direction of the first axis,
the first engagement part includes
a first support-side engagement portion provided at a central portion in the axial direction of the second axis of each of the first extending portion and the second extending portion, and
a first swing-side engagement portion provided on the module holder so as to engage with the first support-side engagement portion, and
the second engagement part includes
a second swing-side engagement portion provided at a central portion in the axial direction of the first axis of each of the third extending portion and the fourth extending portion, and
a second support-side engagement portion provided on the fixed-side member so as to engage with the second swing-side engagement portion.

2. The module drive device according to claim 1, wherein
the first swing-side engagement portion is formed of a first metal member made of a metal plate, and
the second support-side engagement portion is formed of a second metal member made of a metal plate.

3. The module drive device according to claim 2, wherein
the first metal member includes
an embedded portion embedded in the module holder made of a synthetic resin,
the first swing-side engagement portion exposed from the module holder, and
an elastic deformation portion that is elastically deformable, exposed from the module holder, and provided between the embedded portion and the first swing-side engagement portion,
the fixed-side member includes
a base member made of a synthetic resin,
the second metal member embedded in the base member, and
the second metal member includes
an embedded portion embedded in the base member,
the second support-side engagement portion exposed from the base member, and
an elastic deformation portion that is elastically deformable, exposed from the base member, and provided between the embedded portion and the second support-side engagement portion.

4. The module drive device according to claim 3, wherein
the base member includes a pair of wall portions that are disposed outside the connection member and face each other while being spaced apart in the axial direction of the second axis,
the second metal member is embedded in each of the wall portions,
the fixed-side member includes a cover member constituting a housing together with the base member,
the cover member includes a side plate portion disposed outside the wall portion,
one of the second swing-side engagement portion or the second support-side engagement portion is formed in a convex shape along the axial direction of the second axis, and the another is formed in a concave shape along the axial direction of the second axis, and
an engagement dimension in the axial direction of the second axis, between the second swing-side engagement portion and the second support-side engagement portion, being formed by interlocking a portion that has the concave shape and a portion that has the convex shape, is formed so as to be larger than a dimension between the side plate portion and the second support-side engagement portion.

5. The module drive device according to claim 3, wherein
the connection member is formed of a metal plate,
the first extending portion and the second extending portion each include a first opposing plate portion, the first opposing portions facing each other in the axial direction of the first axis,
the first support-side engagement portion is formed in a convex curved shape such that an inner surface of the first opposing plate portion projects inward along the axial direction of the first axis,
the first swing-side engagement portion is formed in a concave curved shape such that an outer surface of the first metal member is recessed inward along the axial direction of the first axis, and
an engagement dimension between the first swing-side engagement portion and the first support-side engagement portion in the axial direction of the first axis is larger than a dimension between an inner surface of a portion where the first swing-side engagement portion of the first metal member is formed and an outer surface of an optical module held by the module holder.

6. The module drive device according to claim 1, wherein
the connection member is formed of a metal plate including a plurality of bent portions,
the first extending portion and the second extending portion includes a first opposing plate portion whose plate surfaces face each other in the axial direction of the first axis,
the first support-side engagement portion is formed in the first opposing plate portion,
the third extending portion and the fourth extending portion include a second opposing plate portion whose plate surfaces face each other in the axial direction of the second axis,
the second swing-side engagement portion is formed in the second opposing plate portion, and
the first support-side engagement portion and the second swing-side engagement portion project in a same direction in a state where the bent portion is unbent so that the plate surfaces of the first opposing plate portion and the second opposing plate portion are parallel to a same imaginary plane.

7. The module drive device according to claim 1, wherein
the driver includes a plurality of shape-memory alloy wires, and
the shape-memory alloy wires are provided at two positions separated in the axial direction of the first axis across the optical module.

8. The module drive device according to claim 7, wherein
the shape-memory alloy wire includes a first wire and a second wire arranged at one position in the axial direction of the first axis, and a third wire and a fourth wire arranged at another position in the axial direction of the first axis,
each of the first wire to the fourth wire has one end fixed to a fixed-side metal member provided on the fixed-side member, and another end fixed to a movable-side metal member provided on a movable-side member including the module holder, and
when viewed along the axial direction of the first axis, the first wire and the second wire intersect each other, and the third wire and the fourth wire intersect each other.

9. The module drive device according to claim 8, wherein
when viewed along the axial direction of the first axis, a first intersection point between a first straight line connecting one end of the first wire and another end of the first wire and a second straight line connecting one end of the second wire and another end of the second wire is at a position different from the first axis, and
when viewed along the axial direction of the first axis, a second intersection point between a third straight line connecting one end of the third wire and the another end of the third wire, and a fourth straight line connecting one end of the fourth wire and another end of the fourth wire is at a position different from the first axis.

10. The module drive device according to claim 8, wherein
the another end of the first wire and the another end of the second wire are electrically connected through a first movable-side metal member, and
the another end of the third wire and the another end of the fourth wire are electrically connected through a second movable-side metal member.
